(19) United States
(12) Patent Application Publication
(10) Pub. No.: US 2006/0265343 A1
(43) Pub. Date: Nov. 23, 2006

(54) Method for estimating main cause of technical problem and method for creating solution concept for technical problem

(75) Inventor: Hideaki Kosha, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/432,487

(22) Filed: May 12, 2006

(30) Foreign Application Priority Data
May 12, 2005 (JP) 2005-140182
Aug. 3, 2005 (JP) 2005-225000
Oct. 4, 2005 (JP) 2005-291474

(51) Int. Cl. G06F 15/18; G06E 1/00; G06E 3/00; G06G 7/00

(52) U.S. Cl. 706/19; 706/20

(57) ABSTRACT

Functions of a whole technical system are regarded as a single conversion process in which an input is converted into an output. The conversion process is observed according to condition changes and divided into plural sub-processes. A phenomenon in each sub-process is analyzed and the sub-process in which the technical problem is occurring is estimated. Thereafter, the main cause of the technical problem is estimated with reference to a technical problem classification system list in which various technical problems are classified and their main causes are systematically organized. Under assumption that the technical system in an ideal state has no technical problem, a solution concept to the technical problem is created is created by finding means for reducing a value in the item selected from the technical problem classification system list to zero.

### BACKGROUND OF THE INVENTION

1. Field of the Invention

The present invention relates to a method for estimating a main cause of a technical problem and a method for creating a solution concept for the technical problem. More particularly, the present invention relates to the method for estimating a main cause of the technical problem applicable to a problem definition in Unified Structured Inventive Thinking (USIT) and a method for creating a solution concept for the estimated technical problem.

2. Description of the Related Art

A methodology for solving technical problems called TRIZ was devised in former Soviet Union in 1946 and has been used in various countries (see TRIZ home page created by Toru Nakagawa on Apr. 5^{th}, 2005, Osaka Gakuin University, searched on May 10^{th}, 2005, URL; http://www.osaka-gu.ac.jp/phph/nakagawa/TRIZ/index.html). TRIZ is a Russian abbreviation for Theory of Inventive Problem Solving, and is constituted of A: Problem solving algorithms for identifying a problem and its cause and selecting a thinking tool to be applied, and B: a technical database classified from plural viewpoints and used for solving the problem.

The methodology of TRIZ and its database are so massive that a great deal of effort is required to understand and utilize them completely. For that reason, TRIZ had been used only in the former Soviet Union until around 1990, and the aid of specifically-trained TRIZ consultants was always necessary.

However, after the collapse of the former Soviet Union, the TRIZ becomes pervasive in many other countries due to an outflow of the TRIZ consultants. Concurrently with the widespread use of the TRIZ, modernization of TRIZ is also advanced to facilitate the TRIZ. For instance, one way of the modernization is to produce software programs which implement the TRIZ on personal computers. Such software programs are produced and sold by companies such as Invention Machine Corporation and Ideation International Incorporation in the United States. Both these programs are common in that they lead engineers to develop analogous thinking while referring to the TRIZ technical database. However, the above software programs differ from each other in basic ideas to access the database.

The software program from Invention Machine Corporation finds a technical problem of a target technical system based on functional relationships between objects in the technical system. Thereafter, some of the objects are excluded through a value engineering method to simplify the technical problem, and a suitable searching tool of the technical database is selected. The program aims at reducing cost in solving the technical problems (see, for instance, U.S. Pat. Nos. 6,202,043, 6,056,428 and Japanese Translation of PCT International Application No. 2001-504966).

The software program produced by Ideation International Incorporation is similar to that of the Invention Machine Corporation in illustrating and organizing the functional relationships between the objects in the technical system. However, this program places greater importance on qualitative analyses than value indexes, and narrows down the scope of the technical problem by organizing the relationships between functions according to whether the functions are useful or harmful. Thereafter, the program presents branch structures, which can be followed interactively, to show a direction to the problem solving and appropriate examples contained in the database (see, for instance, U.S. Pat. No. 5,581,663).

Another direction in the modernization of TRIZ is to simplify a massive and complicated thinking system of TRIZ. It began with Systematic Inventive Thinking (hereinafter referred to as SIT) developed in Israel and is now widely used as Unified Structured Inventive Thinking (hereinafter referred to as USIT) constructed in the United States.

The USIT places importance on the problem solving algorithms of the TRIZ. As shown in FIG. 18, in the USIT, a technical problem of a target system is modeled for simplification in terms of O-A-F (O: Object, A: attribute and F: function). The model is then analyzed to create a solution concept for the root cause of the technical problem (see, for instance, TRIZ home page created by Toru Nakagawa on Apr. 5^{th}, 2005, Osaka Gakuin University, searched on May 10^{th}, 2005, URL; http://www.osaka-gu.ac.jp/phph/nakagawa/TRIZ/index.html).

In the USIT, during creation of solution concept of the technical problem, a plurality of ideas are produced through an object pluralization method, an attributes dimensionality method, a function distribution method and so forth. Such ideas are generalized and combined to create the solution concept. In the object pluralization method, the number of the objects is increased or the objects are divided. The attribute dimensionality method focuses on the unused attributes, and/or emphasizes or restricts the relationships between the attributes and functions. In the function distribution method, the functions are rearranged to the different objects.

In the conventional problem solving methods related to the TRIZ and the USIT, the cause of the problem is determined based on the functional analyses and the functional relationships between the objects. Although the functions are differently treated in the above methods, all of the above methods are the same in that the functions of the objects are firstly identified. If a target technical system is a mechanical system, it is easy to identify the function of each object and the functional relationships between the objects, since the functional relationships in such technical system are visible. However, if a target technical system is an extremely micro technical system or a chemical system, the functional relationships in the whole system are hardly understood even by the designer of the system, and the identification of the technical problem becomes difficult. Also, the identification of the problem is difficult for inexperienced engineers not having the skill to identify the functions.

To the above technical system in which the identification of the functions is difficult, it may be better not to identify the functions at first. Instead, it is considered reasonable that the clear understanding of a phenomenon occurring in the technical system enables the engineer to estimate the functions which support the phenomenon. However, in such systems, plural phenomena often link together in a complicated manner. For that reason, it is important to find a phenomenon strongly associated with the functions and the technical problem.

When using the TRIZ, it is necessary to search for the similar example through the massive database and apply the solution concept of the searched example to the existing technical problem. Accordingly, mastering the TRIZ is difficult and requires a long time. In addition, the creation of the solution concept by using the USIT requires a wide range of knowledge about the objects, attributes and functions. Accordingly, it is difficult for the inexperienced engineers.

### SUMMARY OF THE INVENTION

In view of the foregoing problems, an object of the present invention is to provide a method for estimating a main cause of a technical problem in even technical systems whose functions are difficult to be identified.

Another object of the present invention is to provide a method for estimating the main cause of the technical problem which enables inexperienced engineers to estimate the main cause of the technical problem.

Still another object of the present invention is to provide a method for creating a solution concept of the technical problem which enables the inexperienced engineers to estimate the main cause of the technical problem.

In order to achieve the above and other objects and advantages of this invention, the method for estimating a main cause of the technical problem organizes functions of a technical system, a target for the main cause estimation, as a single conversion process for converting an input into an output. The conversion process is divided into plural sub-processes according to condition changes in the conversion process. A function of each of the sub-processes is estimated by analyzing the phenomenon in the sub-process with reference to the function of the whole conversion process, and the sub-process that causes the technical problem is then estimated. The phenomenon in the estimated sub-process is analyzed with reference to a technical problem classification system list which classifies and systemizes various sorts of technical problems and their main causes, so that a main cause of the existing technical problem is estimated.

The phenomenon is an influence by an attribute of an object on an attribute of another object in a certain field which is energy and force. Among actions caused by the influence, those controllable and giving useful effects are defined as the functions and those not controllable and giving harmful functions are defined as the technical problems. Thereby, even the inexperienced engineers are able to estimate the technical problem easily.

Further, in the step to estimate the sub-process in which the technical problem is occurring, a goal achievement level and a present achievement level of the function of the sub-process are analyzed. Thereby, even the inexperienced engineers are able to estimate the technical problem easily.

In the analysis of the phenomenon, a phenomenon-analysis flow having plural question items interrelating to the phenomenon is used, and the phenomenon and the function of the sub-process are estimated by sequentially answering each of the question items. Thereby, even the inexperienced engineers are able to estimate the functions of the sub-processes, and the technical problem easily. Note that when the phenomenon is analyzed, text and illustration are used for describing the estimated phenomenon. The text and the illustration facilitate to organize the phenomenon.

The technical problem classification system list classifies the technical problem under categories of, at least, an achievement level of the function of the sub-process, stability of the function achievement level, and the harmful function, and the each category is divided into plural items corresponding to main causes based on temporal and spatial perspectives.

According to a present invention, a method for creating a solution concept for solving a technical problem uses the above method for estimating the main cause of the technical problem to find the sub-process which causes the technical problem and the main cause of the technical problem. It is assumed that the ideal state doe not have the technical problem, and the energy and the movement of the substance to achieve the ideal state are then examined. The attributes of the materials and the members which relate to the ideal state are listed and a means for achieving the ideal state is established by combining the examined energy, movement and listed attributes.

The ideal state is a state in which the value of the item in the technical problem classification system list estimated as the main cause of the technical problem is zero. In the step in which the ideal state is assumed, the ideal state is described by text and illustration to facilitate the understanding.

In a computer program for executing a method for estimating a main cause of a technical problem, a function of the whole technical system is regarded as a single conversion process in which an input is converted into an output, and an initial state and a final state of the conversion process are input. The sub-processes created by dividing the conversion process based on condition changes in the conversion process are input. An explanation of a phenomenon occurring in each of the sub-processes is input. Then, the estimated function of each of the sub-processes is input. A technical problem classification system list is displayed in which various sorts of technical problems and their main causes are classified and systematized. The main cause of a technical problem occurring in a sub-process is selected from the list and input. Based on contents input in each of the above steps, a phenomenon-attribute analysis table is produced. Thus, the phenomenon-attribute analysis table which is useful for the estimation of the technical problem is easily produced.

After the main cause of the technical problem is input, the explanation of the phenomenon of the ideal state may be input. The ideal state is the state in which the technical problem does not exist. In addition, the attributes of the materials and of members related to the ideal state, and a means for achieving the ideal state established from the above input contents may be input. Thereby, the creation of the solution concept is facilitated.

When the explanation of the phenomenon of the ideal state is input, it is preferable to display the explanation of the phenomenon in the sub-process with the technical problem for comparison. Thereby, the assumption of the ideal state is facilitated.

Further, it is preferable to input a function achievement evaluation item to evaluate an achievement of a function in the sub-process, and a goal value and a present value of the function achievement evaluation item. A difference between the goal value and present value is obtained, and the function achievement evaluation items are ranked according to an amount of the difference. Thereby, the understanding of the contents of the technical problem is facilitated.

Further, in each input step, the input item providing tips for the contents to be input and the input support items elaborating on the input item are preferably displayed. Thereby, even the inexperienced engineers are able to understand the contents of the input item and to input appropriate contents.

Further, in each input step, it is preferable to display the technical problem classification system list and the phenomenon-attribute analysis table under creation in response to an access operation. Thereby, the necessary contents are input while referring to the above lists.

According to the method for estimating the main cause of the technical problem, the function is estimated from the phenomenon. Accordingly, the technical problem is properly estimated even in the technical system in which the function is not identified, or by the inexperienced engineers. Since the whole technical system is regarded as a single conversion process and the phenomenon is analyzed by dividing the conversion process into the plural sub-process according to the condition changes, appropriate analysis of the phenomenon, estimation of the function and the estimation of the technical problem are performed even in a complicated system. Further, the main cause of the technical problem is estimated while referring to the technical problem classification system list, even the inexperienced engineers are therefore able to solve the problem appropriately.

In the method for creating the solution concept of the technical problem in the present invention, a state in which the technical problem does not exist is defined as the ideal state, and the movements of the energy and the substances to achieve the ideal state are examined. Accordingly, the direction of the solution concept is clarified. Further, the attributes related to the main cause of the technical problem and to the ideal state are listed. By combining and examining the listed attributes, the energy, and the movement of the substance, an optimum solution concept is obtained.

In the computer program for estimating the main cause of the technical problem of the present invention, the main cause of the technical problem is estimated by inputting the contents according to the instructions of the computer. Accordingly, even young engineers and/or the inexperienced engineers are able to work on the program without inhibitions. Further, since the input operations can be performed while checking the input contents on the screen in accordance with the input speed, the computer supports the thinking operations to comprehend the whole image of the technical problem. Further, since the phenomenon-attribute analysis table is produced based on the input contents, the phenomenon-attribute analysis table facilitates to comprehend the whole image of the technical system and enables further examination based on the phenomenon-attribute analysis table. Further, since the technical problem classification system list is incorporated in the program to be referred to in accordance with the access operation as necessary, even the inexperienced engineers are able to estimate the basic technical problem classified under the temporal and the spatial perspectives from which the technical problem in each sub-process is derived. Further, when the ideal state is assumed, the state in which the value of the item corresponding technical problem is reduced to zero is estimated. The concrete image of the ideal state is obtained by referring to the technical problem classification symbol so that the inexperienced engineers are able to assume the ideal state easily.

### BRIEF DESCRIPTION OF THE DRAWINGS

The above objects and advantages of the present invention will become more apparent from the following detailed description when read in connection with the accompanying drawings, in which:

FIG. 1 is a conceptual drawing illustrating a relationship between a phenomenon and functions in a unit technical system;

FIG. 2 is a flow chart illustrating steps of a method for estimating a cause of a technical problem in the present invention;

FIG. 3 is a conceptual drawing illustrating a configuration when a technical system is regarded as a conversion process;

FIG. 4 is a conceptual drawing illustrating the conversion process divided into plural sub-processes;

FIG. 5 is a table illustrating items used in a phenomenon-attribute analysis in the sub-process;

FIG. 6 is an explanatory view illustrating a phenomenon-analysis flow;

FIG. 7 is a technical problem classification system list;

FIGS. 8A and 8B are technical problem classification symbol lists;

FIGS. 9A, 9B and 9C are section views illustrating processes of a CTP printing;

FIG. 10 is sub-processes of an exposure to image formation process;

FIG. 11 is a conceptual drawing of a sub-process ii;

FIG. 12 is a phenomenon-attribute analysis of the sub-process ii;

FIG. 13 is an explanatory view illustrating an analysis example of the sub-process ii;

FIG. 14 is a flow chart illustrating steps of creating a solution concept to the technical problem from an ideal state;

FIG. 15 is a format for the phenomenon-attribute analysis used for considering a gap between the ideal state and the present state as the technical problem;

FIGS. 16A and 16B are the phenomenon-attribute analysis tables of the sub-process iv;

FIGS. 17A and 17B are the phenomenon-attribute analysis tables of the sub-process iv;

FIG. 18 is an explanatory view illustrating relationships between O: object, A: attribute, and F: function in Unified Structured Inventive Thinking (USIT);

FIGS. 19A, 19B and 19C are explanatory views illustrating a part of the items in the phenomenon-attribute analysis table created by a computer program for estimating a main cause of a technical problem;

FIGS. 20A, 20B and 20C are explanatory views illustrating another part of the items in the phenomenon-attribute analysis table;

FIG. 21 is a block diagram illustrating a configuration of a computer system in which the estimation program is executed;

FIG. 22 is a block diagram illustrating a function of a CPU when the estimation program is started up;

FIG. 23 is a flow chart illustrating operation steps of the estimation program;

FIG. 24 is a flow chart illustrating processing steps of the estimation program;

FIG. 25 is an explanatory view illustrating an initial screen of the estimation program;

FIG. 26 is an explanatory view illustrating an input screen of a step 1 in the estimation program;

FIG. 27 is an explanatory view illustrating an input screen of a step 2 in the estimation program;

FIG. 28 is a list illustrating input items and support items in each step;

FIG. 29 is an explanatory view illustrating an input screen on which the technical problem classification system list is displayed;

FIG. 30 is an explanatory view illustrating an input screen on which the technical problem classification symbol list is displayed;

FIG. 31 is an explanatory view illustrating a table reference screen on which the phenomenon-attribute analysis table under creation is displayed;

FIG. 32 is an explanatory view illustrating an input screen of a step 9 in the estimation program; and

FIG. 33 is an explanatory view illustrating a state in which input contents of the step 9 and the step 3 are displayed together.

### DETAILED DESCRIPTION OF THE PREFERRED EMBODIMENT(S) OF THE PRESENT INVENTION

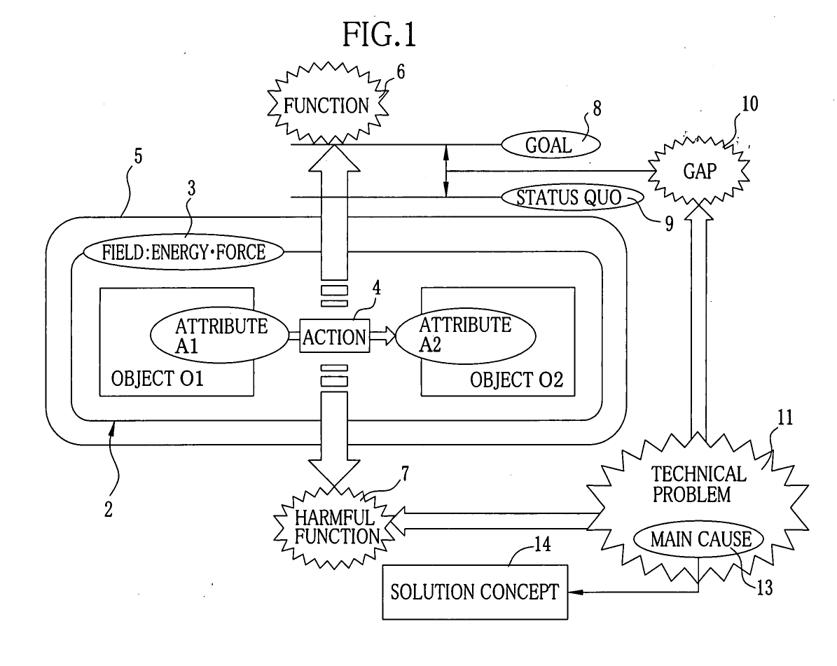

In FIG. 1, a unit technical system 2 describes a unit phenomenon constituted of, for instance, an object O1 and an object O2. In the technical system 2, an influence of an attribute A1 of the object O1 on an attribute A2 of the object O2 under a certain field, that is, energy and force 3 is defined as an action 4. The above elements are altogether defined as a phenomenon 5. If the action 4 is controllable and useful, it is defined as a function 6, while the action 4 is not controllable and harmful, it is defined as a harmful function 7. The function 6 takes one of two levels, a goal level 8 to be achieved and a status quo level 9 which has not yet achieved the goal level 8. A gap 10 between the goal level 8 and the status quo level 9 is a problem to be solved. Therefore, the gap 10 and the harmful function 7 are defined as technical problems 11.

The technical problem varies among the unit technical systems. However, main causes of the different technical problems are often common and can be generalized as an excess, and insufficiency or instability of a level for achieving the function. In the present invention, the main cause of each technical problem is defined as a main cause 13. Further, a means for solving the technical problems 11 is defined as a solution concept 14. An ideal state in the unit technical system is a state in which the technical problem does not exist, that is, a state in which the main cause of the technical problem does not exist. Therefore, in the present invention, the solution concept 14 is one that provides a means to reduce the value indicating the main cause to zero.

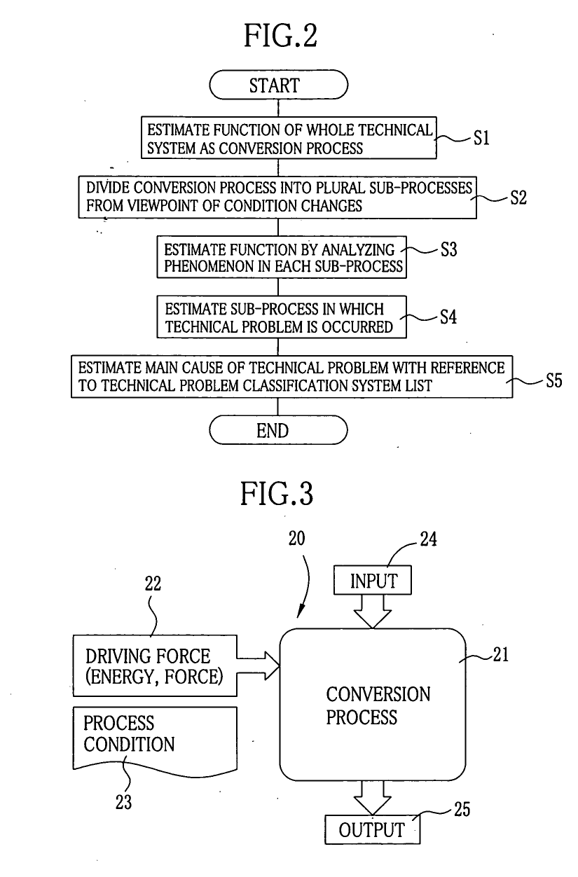

Actual technical systems are not as simple as the above described unit technical system 2 which has only two objects, and often have complicated configurations in which plural objects and their attributes are combined. Accordingly, it is difficult to pick up each phenomenon and estimate the functions therefrom. In the present invention, as shown in FIG. 2, the main cause of the technical problem is estimated through steps S1 to S5. In the step S1, functions in the whole technical system are regarded as a single conversion process which converts an input into an output. In the step S2, the conversion process is observed from a viewpoint of condition changes and is divided into plural sub-processes according to the condition changes. In the step S3, the function of each sub-process is estimated by analyzing the phenomenon by applying each sub-process to the conceptual drawing of FIG. 1. In the step 4, the sub-process in which the technical problem is occurring is estimated. In the step S5, the main cause of the technical problem is estimated.

In FIG. 3, a conversion process 21 converts an input 24 into a predetermined output 25 under a driving force (that is, energy and force) 22 and a process condition 23. Any technical systems can be depicted in the conversion process of the same conceptual drawing regardless of the type of the system, for instance, an engineering system, electric and electronic systems, a chemical system and so forth.

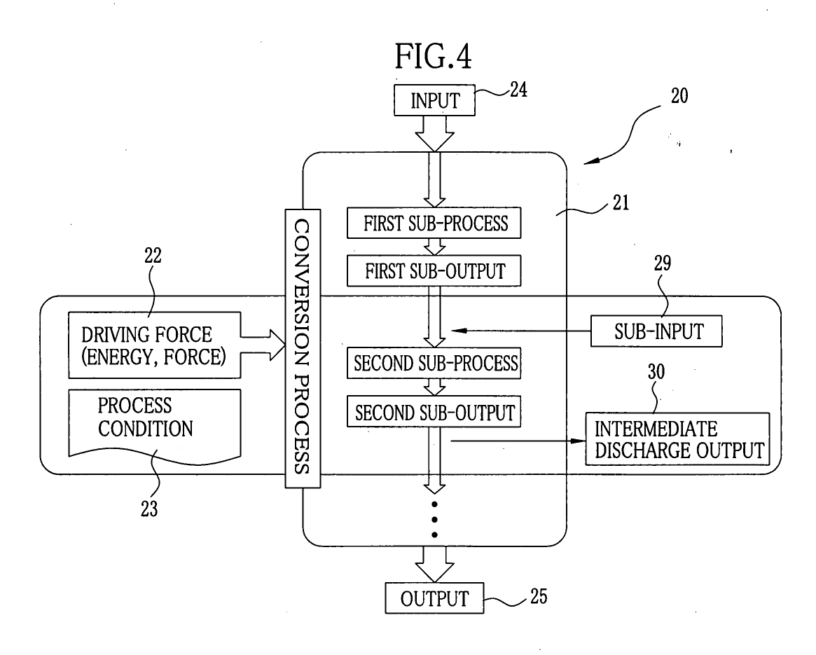

Next, as shown in FIG. 4, the conversion process 21 of the above technical system 20 is divided into plural sub-processes. In the present invention, the conversion process 21 is divided in view of condition changes. In addition to the condition changes which are visible and observed through experiments, the condition changes estimated with a logic that, for instance, a certain condition inevitably happens during a certain process are also used. At the time of dividing the conversion process into the sub-processes, it is possible to improve the accuracy of the division by literalizing the whole flow in the conversion process 21 and illustrating each sub-process.

Some of the sub-process, for instance, a second sub-process may have a sub input 29 and an intermediate discharging output 30. The sub input 29 is some sort of input operation during the process. The intermediate discharging output 30 is an output operation for discharging an intermediate product and the like during the process. Since such sub-process is constituted of a minimum component and the driving force 22, the phenomenon analysis are performed in the same manner as the conceptual drawing in FIG. 1.

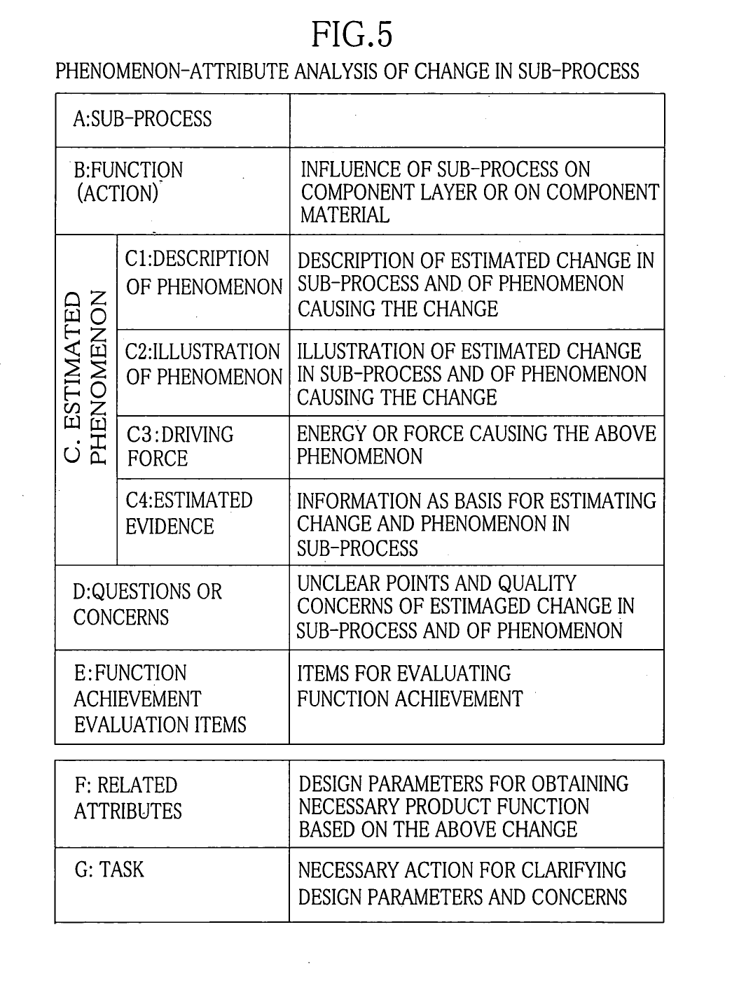

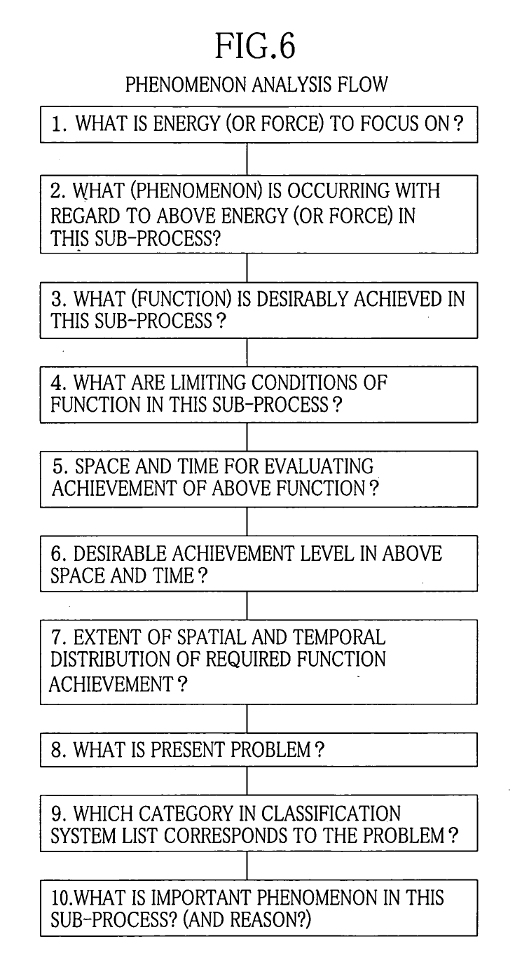

For an analysis of the phenomenon and the attributes in the second sub-process, a phenomenon-attribute analysis table in FIG. 5 and a list of phenomenon analysis flow in FIG. 6 are preferably used. The phenomenon-attribute analysis table is constituted of plural frames A to G each of which is listed with various items for analyzing the phenomenon and the attributes in the sub-process. For instance, the frames A to E are used for analyzing the phenomenon, and the frames F and G are used for organizing the items related to the results of the analysis. Examples of the frames A to E are as follows; A: sub-process, B: function (action), C: estimated phenomenon, D: questions, or concerns due to an excess and insufficiency, or variations of the function, and E: function achievement evaluation items. Examples of the frames F and G are as follows; F: related attributes, and G: tasks. Further, the frame C: the estimated phenomenon is constituted of a frame C1: description of the phenomenon, a frame C2: illustration of the phenomenon, a frame C3: a driving force, and a frame C4: estimated evidences, that is, experiments and references.

In the frame A: sub-process, a name of the sub-process showing a content of the sub-process is described. In the frame B: function (action), an influence of the sub-process on an object layer and/or an object material is described. In the frame C1: description of the phenomenon, an estimated change during the sub-process and the phenomenon causing such change are described. In the frame C2: illustration of the phenomenon, the phenomenon described in the frame C1 is illustrated. In the frame C3: driving force, energy and force causing the phenomenon in the sub-process are described. In the frame C4: estimated evidence, informations of the experiments and/or the references forming the basis for estimating the change or the phenomenon in the sub-process are described. In the frame D: questions or concerns due to an excess and insufficiency or variations of the function, unclear points regarding the estimated change and/or phenomenon and/or the concerns about the quality of the product and so forth are described. In the frame E: function achievement evaluation items, the items for evaluating the achievement of the function are described.

In the frame F: related attributes, design parameters are described to obtain the necessary product function based on the changes listed above. In the frame G: tasks, actions to be implemented are described to clarify the design parameters and the concerns.

The phenomenon analysis flow is in a question form, for instance, having questions No. 1 to 10. The phenomenon of the sub-process is analyzed and its function is estimated by answering the questions No. 1 to 7. Further, the contents of the technical problem, the sub-process in which the technical problem is occurring, and the main cause of the technical problem are estimated by answering the questions No. 8 to 10 in view of the questions No. 1 to 7.

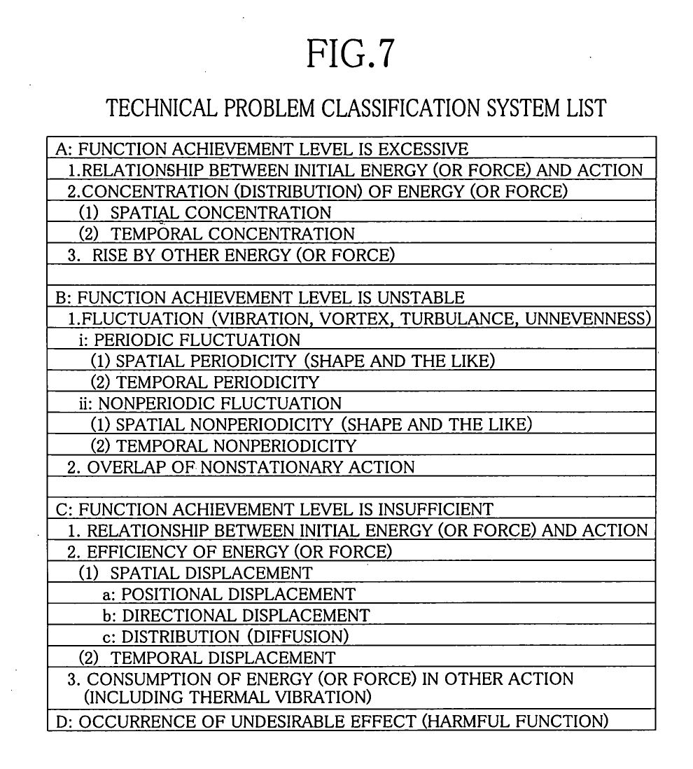

In the question No. 9 in the above phenomenon analysis flow, the main cause of the technical problem is estimated and generalized by using a technical problem classification system list of the present invention. As shown in FIG. 7, the technical problem classification system list classifies the technical problems under four categories, and specifies the main causes in each category according to temporal and spatial perspectives. The four categories are as follows; A: function achievement level is excessive, B: function achievement level is unstable, C: function achievement level is insufficient, and D: undesirable effect (harmful function) is occurred. By using the technical problem classification system list, the main cause of the technical problem in the sub-process is determined and generalized according to the function achievement level and/or its stability.

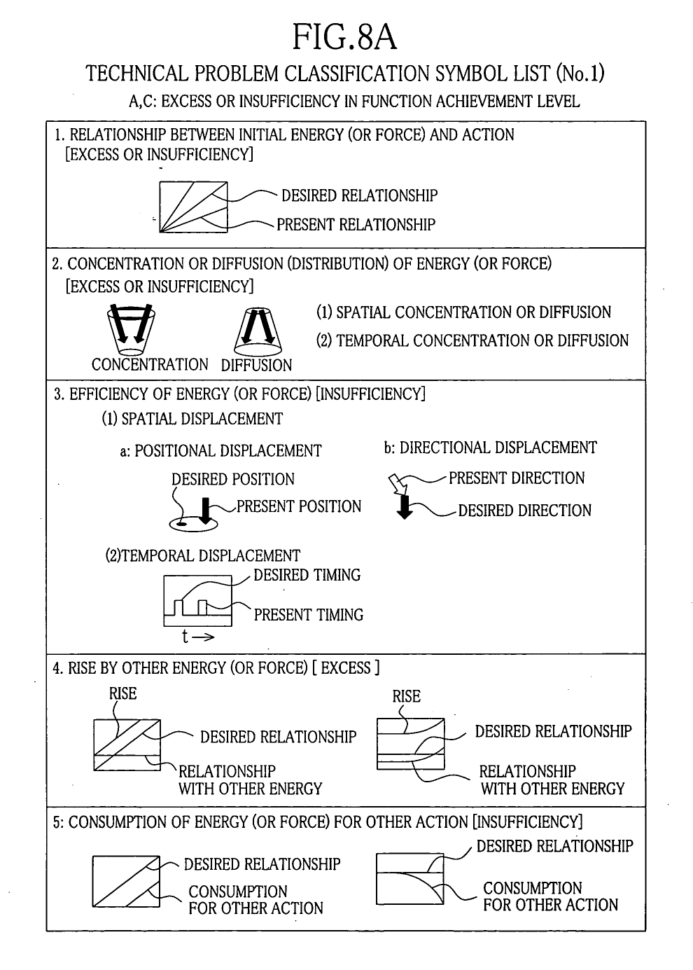

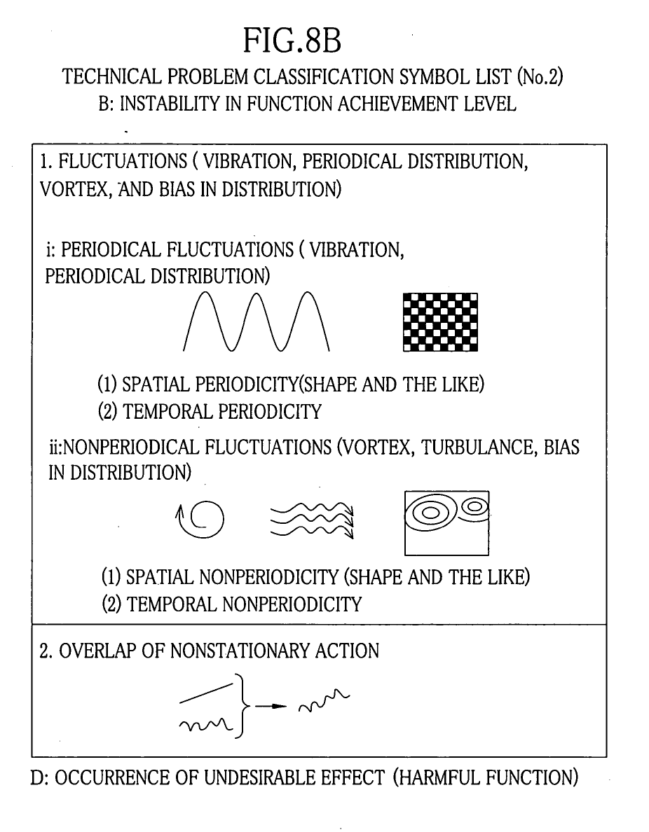

As shown in FIGS. 8A and 8B, each item in the above technical problem classification system list is symbolized in a simple form to depict the content of the item and used as a technical problem classification symbol. When the main cause of the technical problem in the sub-process is determined, it is difficult to grasp an image of the main cause only by the descriptions of the technical problem classification system list in FIG. 7. However, the technical problem classification symbols allow to understand the problem visually and facilitates the determination of the main cause. The technical problem classification symbol also serves as a reference drawing for illustrating the phenomenon of the sub-process. By referring to the technical problem classification symbol during the illustration of the phenomenon, the determination of the technical problem is more facilitated. In addition, the technical problem classification symbols help to clarify the phenomenon in the sub-process when the technical problem classification symbols are put in the frame D: questions or concerns due to an excess and insufficiency or variations of the functions, of the above phenomenon-attribute analysis.

In the technical problem classification system list and the technical problem classification symbol list shown in FIGS. 7, 8A and 8B, the items directional displacements, diffusion and concentration are classified as separate items in the frames A and C despite that the diffusion and the concentration may be considered as kinds of directional displacements because the diffusion and the concentration give different impressions from the directional displacements. However, it is also possible to include the diffusion and the concentration in the directional displacements.

As described above, the technical system is regarded as the conversion process, which is divided into the sub-processes, and the phenomenon in each sub-process is analyzed to estimate the function. Accordingly, it becomes possible to estimate the functions and the main cause of the technical problem from the phenomena even in a micro technical system or in a chemical technical system. Further, inexperienced engineers are also able to estimate the functions from the phenomena to estimate the cause of the technical problem.

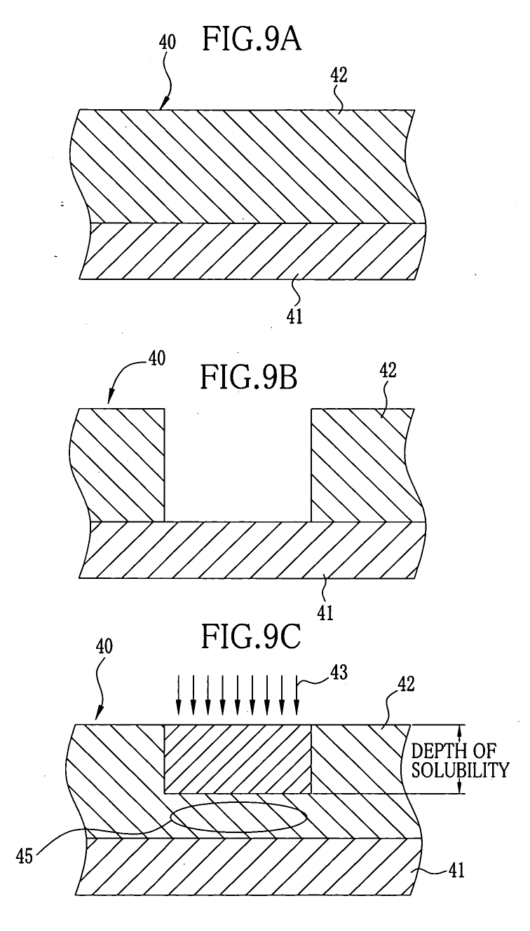

Next, a concrete example of the present invention is explained. In FIG. 9A, a CTP (Computer To Plate) printing plate 40 is a printing plate on a surface of which an image is directly printed from a digital data in a computer. The CTP printing plate 40 is constituted of, for instance, an aluminum substrate 41, and a resin layer 42 provided on the aluminum layer 41. the resin layer 42 is formed of a photosensitive resin containing IR dye. When laser light is emitted to the resin layer 42 of the CPT printing plate 40, the IR dye absorbs the laser light and converts the laser light into heat, so that the photosensitive resin is modified to obtain alkali solubility. Thereafter, an alkali-soluble portion of the photosensitive resin is removed by alkali development. Thus, an off-set printing plate is formed as shown in FIG. 9B.

However, as shown in FIG. 9C, in the conventional CTP printing plate 40, the alkali solubility is not imparted to a resin layer 45 in the proximity of a surface of the aluminum substrate 41 when the laser light 43 is emitted to the resin layer 42. As a result, the resin layer 45 is not removed. Because of the remaining resin layer 45, the engraving of the printing plate becomes shallow and the image quality is degraded. To solve the above problem, the experiments are performed by changing the concentrations and the types of the IR dye. However, sufficient alkali solubility is not provided to the resin layer 45 at the depth of the surface of the aluminum substrate 41.

In the application of the present invention to the above example, the technical system of the example is assumed as one conversion process. In this case, the CTP printing plate 40 is defined as an input, the CTP printing plate imparted with the solubility is defined as the output, the light is defined as energy, and the photosensitive resin and the IR dye are defined as the process conditions.

For dividing the technical system into plural sub-processes, the functions and the actions of the whole technical system are literalized. Note that the functions and the actions are picked up in view of the condition changes which are those visible, and observed through the experiments, and further those estimated with the logic that a certain condition inevitably happens when the condition changes from a one state to a next state. Examples of such text are as follows:

The laser light reaches the surface of the photosensitive resin layer.

The laser light passes through the photosensitive resin layer.

The laser light is absorbed by the IR dye.

The IR dye is heated.

The heat of the IR dye is transferred to the photosensitive resin layer.

The photosensitive resin layer is solubilized.

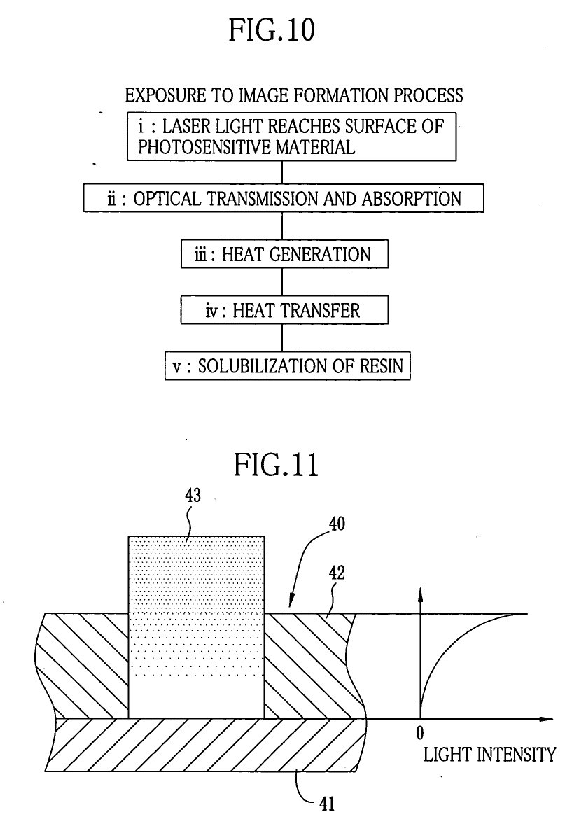

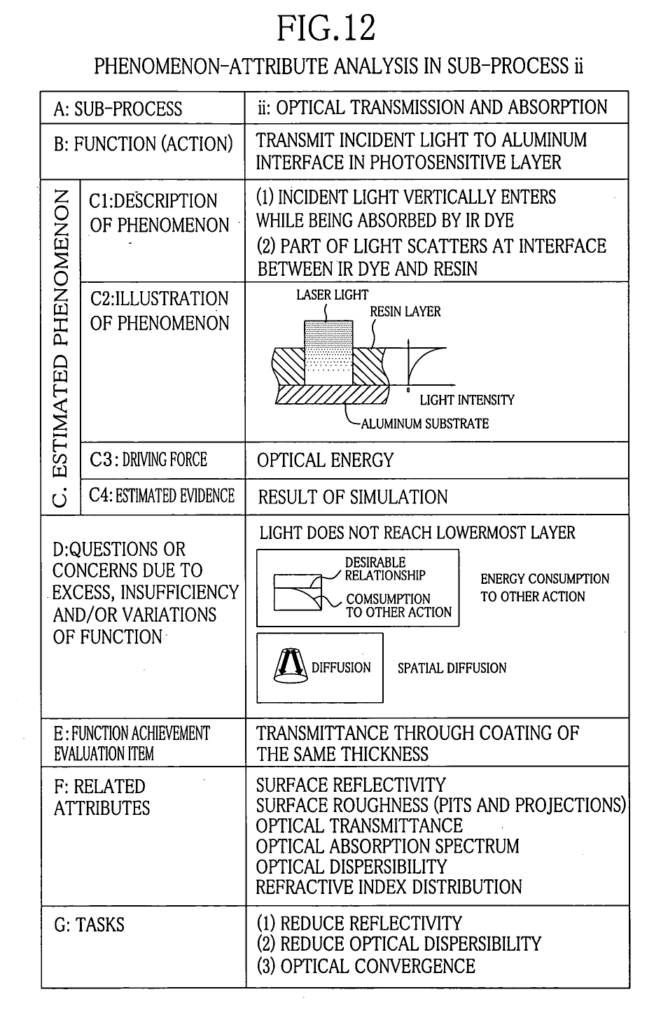

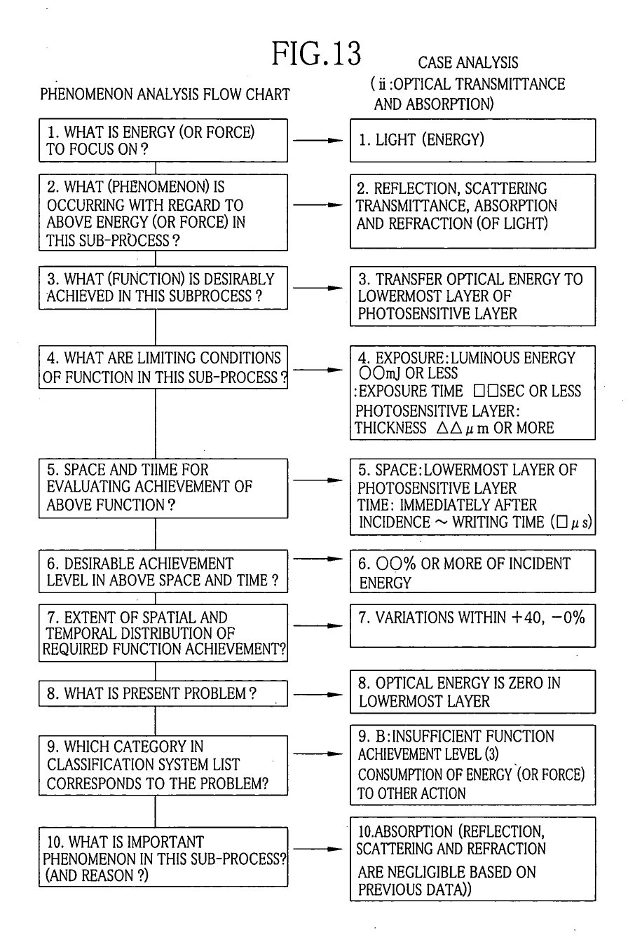

Referring to FIG. 10, the cause of the technical problem in this technical system is estimated that the resin layer 45 is not heated, or the heat is not transferred thereto. Accordingly, it is estimated that the technical problem is in sub-process ii: optical transmission and absorption, the sub-process iii: heating, and the sub-process iv: heat transfer. Regarding the sub-processes ii to iv, the phenomenon analysis is carried out by using the phenomenon-attribute analysis table and the list of the phenomenon analysis flow. In FIGS. 11 to 13, the conceptual drawing, the phenomenon-attribute analysis, and phenomenon analysis flow describing the sub-process ii: optical transmission and absorption are illustrated as examples.

According to the above phenomenon-attribute analysis table and phenomenon analysis flow, the cause of the insoluble resin layer 45 is estimated that the laser light 43 is absorbed by the IR dye so that the light intensity in the proximity of the aluminum substrate 41 is reduced to zero, and that a part of the light is scattered at the interface of the IR dye and the resin. When the above technical problem is applied to the technical problem classification system list in FIGS. 7, 8A and 8B, the technical problem corresponds to the category C: function achievement level is insufficient. More particularly, the causes of the above problem correspond to the item 3: consumption of energy to other action, and the item c: diffusion in the item (1): spatial displacement of the item 2: energy efficiency.

Further, in view of the limiting factors such as the light emission energy, and the thickness of the photosensitive layer, the above phenomenon-attribute analysis clarifies that the increase in the concentration of the IR dye is not appropriate for increasing the temperature of the lowermost layer. The phenomenon-attribute analysis also clarifies that appropriate solutions may be of increasing the photothermal conversion efficiency of the IR dye, optimizing the distribution of the IR dye (that is, to place the IR dye closer to the substrate), and controlling luminous intensity distribution of the IR dye.

In the above embodiment, the example is described in which the gap between the present function and the goal function is recognized as the technical problem. However, it is also possible to assume an ideal state of the sub-process and recognize a gap between the ideal state and the present state. Based on the above recognition, the solution concept of the technical problem is created by the relationships between the ideal state and the technical problem. Note that the ideal state in the technical system means a state in which any technical problem does not exist. In other words, the ideal state is a state in which a value of the item in the technical problem classification system list corresponding to the estimated main cause of the technical problem becomes zero.

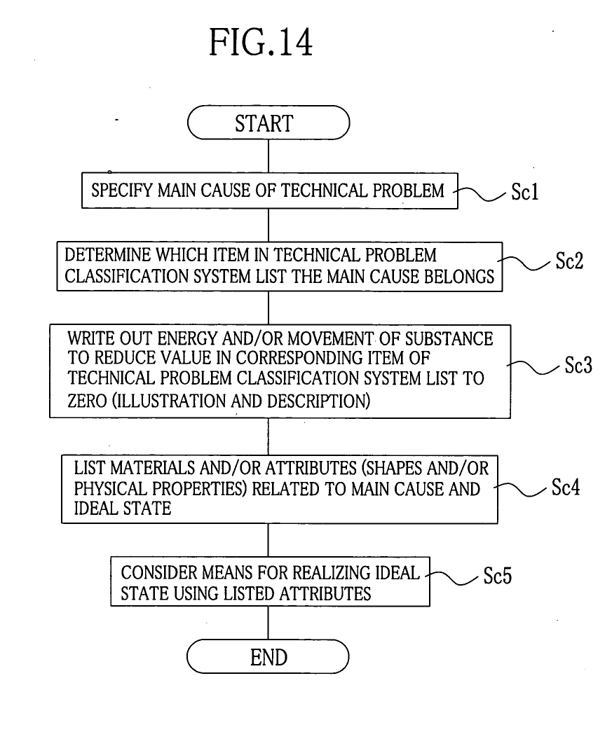

Steps for creating the solution concept according to the present invention are constituted of the steps Sc1 to Sc5 shown in FIG. 14. In the Step Sc1, the content of the technical problem is found. In the Step Sc2, it is determined to which item in the technical problem classification system list the technical problem belongs. In the step Sc3, to reduce the value of the determined item in the technical problem classification system list to zero, movements of energy and substances are described and illustrated. In the step Sc4, attributes (shape, physical properties and so forth) of materials and/or members which are considered to be relative to the technical problem classification system list and the ideal state are listed. In the step Sc5, means for achieving the ideal state is formulated by using the listed attributes.

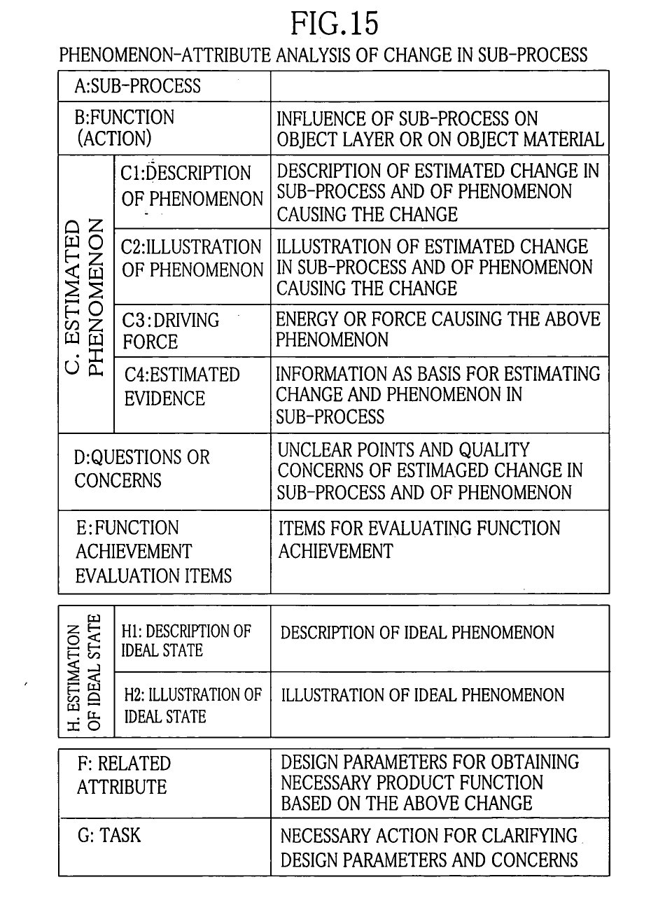

To create the solution concept, for instance, a phenomenon-attribute analysis table shown in FIG. 15 is used. Frames A to G of the phenomenon-attribute analysis are the same as that illustrated in FIG. 5 except that a frame H: estimation of the ideal state is added. The frame H is constituted of a frame H1: description of the phenomenon and H2: illustration of the phenomenon. In the frame H1, the ideal state is described. In the frame H2, the description in the frame H1 is illustrated.

In the following, the steps for creating the solution concept of the main cause of the technical problem are described by using the sub-process iv: heat transfer as an example. The intended function in this sub-process is to transfer heat through the resin layer 42 to the interface between the resin layer 42 and the aluminum substrate 41. However, in the present state, the heat does not reach the aluminum substrate 41 and the resin layer 45 to which the solubility is not imparted remains unremoved.

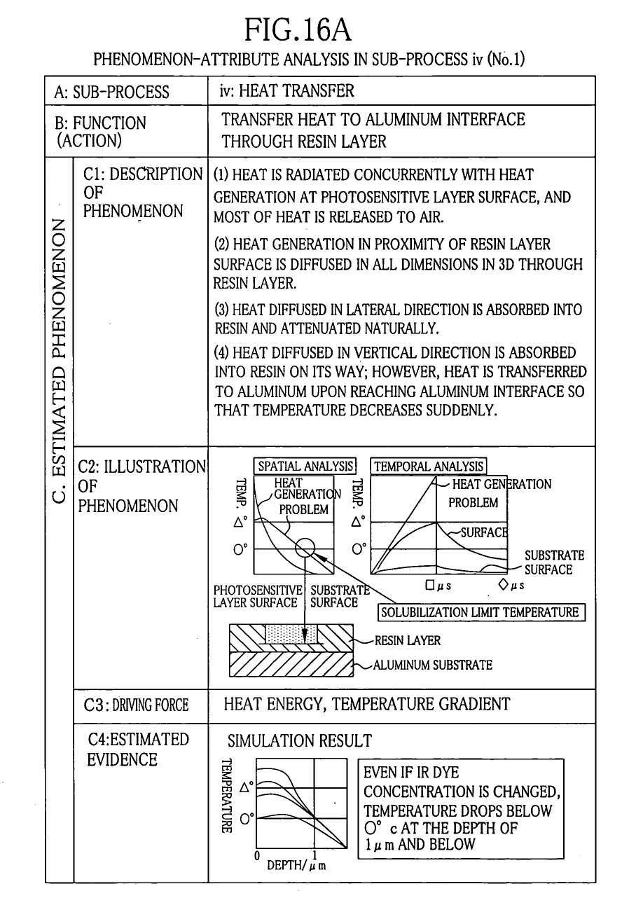

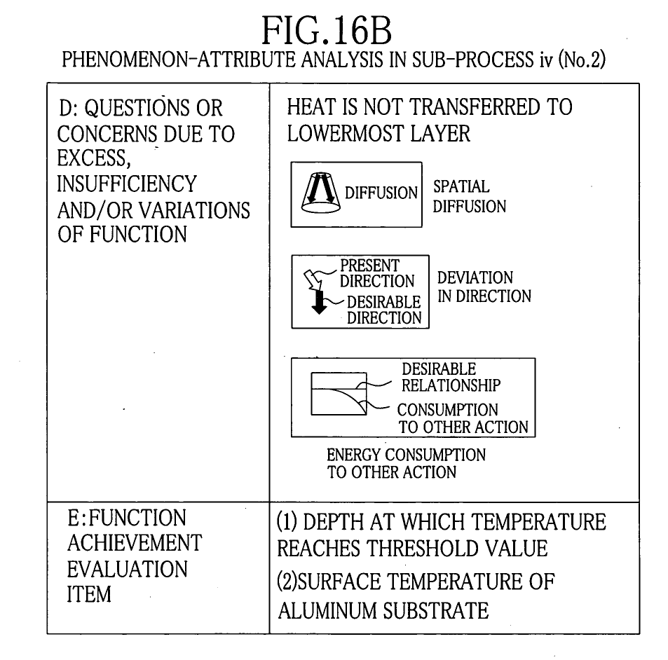

As described in the frame B: description of a phenomenon of the phenomenon-attribute analysis table in FIG. 16A, the heat is not transferred to the interface between the resin layer 42 and the aluminum substrate 41 due to the following causes: (1) the thermal radiation becomes significant once the photosensitive layer surface gets hot, and most of the heat is released to the air; (2) the heat in the proximity of the resin layer surface is diffused in all directions through the resin layer; (3) the heat diffused in the lateral directions is absorbed into the resin and attenuated naturally; and (4) The heat diffused in the vertical directions penetrates the resin to a certain depth. However, the heat flows into the aluminum substrate upon reaching around the aluminum interface, and the temperature decreases suddenly. These estimations are derived from a graph depicting the relationship between the thickness of the resin layer and the temperature, and a graph depicting the heat transfer time through the resin layer in the frame C2: illustration of the phenomenon, and a graph of the simulation result showing the relationship between the IR dye concentration and the heat-transfer depth in the frame C4: the estimated evidence of the phenomenon-attribute analysis.

The main cause is estimated by applying the above estimated phenomena (1) to (4) to the technical problem classification system list in FIGS. 7 and 8. The main cause of the phenomenon (1) is estimated to be the spatial diffusion of the heat. The cause of the phenomena (2) and (3) are estimated to be the directional displacements of the heat transfer. The main cause of the phenomenon (4) is estimated to be the energy consumption by other actions.

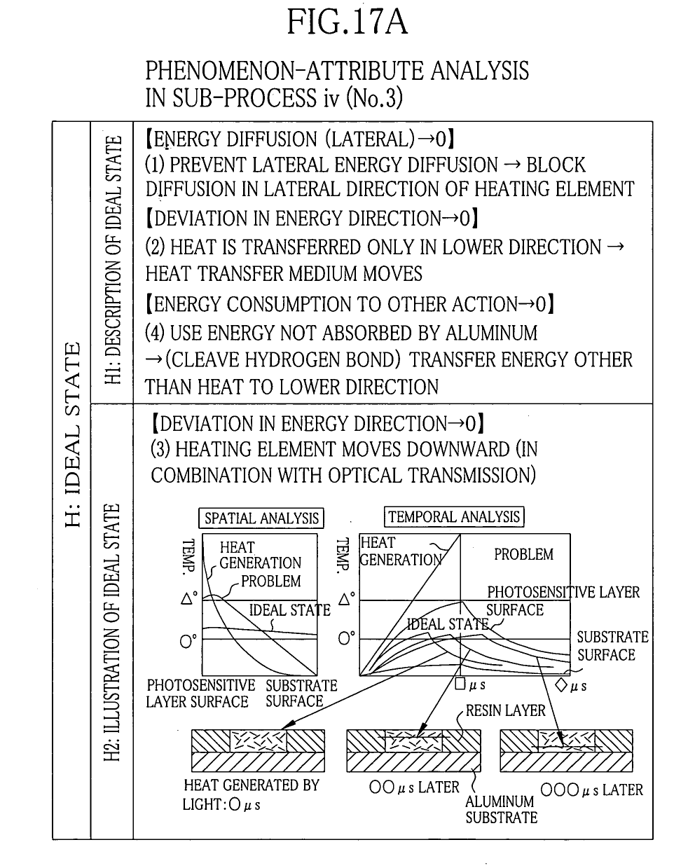

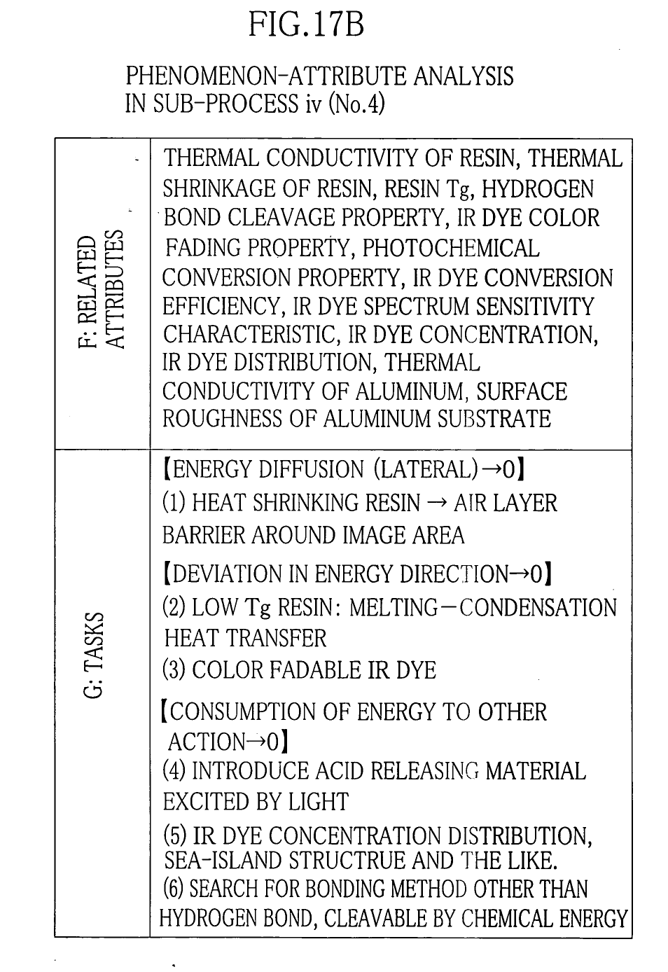

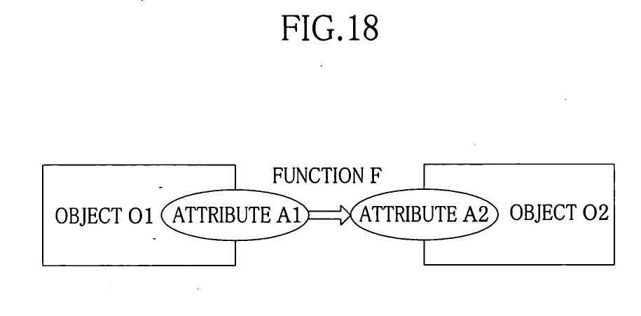

The frame H1: description of the ideal state of a phenomenon-attribute analysis in FIG. 17A describes the ideal state in which the value of the item corresponding to the main cause of the technical problem becomes zero. The heat energy should be diffused in the thickness direction of the resin layer 42 and it is evident that the diffusion in the lateral direction wastes the heat energy. Accordingly, an ideal state 1 is a state in which the diffusion of the heat energy in the lateral direction is reduced to zero. Further, since the heat energy should be transferred only in the thickness direction of the resin layer 42, an ideal state 2 is a state in which the displacement in the heat transfer direction is reduced to zero. Furthermore, since the heat energy should heat the resin layer 42 without being absorbed into the aluminum substrate 41, an ideal state 3 is a state in which the absorption of the heat energy into the aluminum substrate 41 is reduced to zero.

The movements of the energy and the substances to realize the ideal state 1 are thought of blocking the heat at the sides of the heating surface. The movements of the energy and the substances to realize the ideal state 2 are thought of moving the heat transfer medium such that the heat is transferred only to the lower side or moving the heating surface to the lower side in association with the optical transmittance. The movements of the energy and the substances to realize the ideal state 3 are thought of using the energy not absorbed by the aluminum, for instance, energy other than heat which can cleave the hydrogen bond. As an example, the frame H2: illustration of the ideal state in FIG. 17A contains the illustration of the ideal state in which the heating surface is moved to the lower side. The above illustration is constituted of the graph showing the relationship between the thickness of the resin layer and the temperature, the graph showing the heat transfer time through the resin layer, and the conceptual drawing showing the moving condition of the heating surface through the resin layer 42.

In the frame F: related attributes in a phenomenon-attribute analysis table in FIG. 17B, the attributes of the materials and/or members considered to be relative to the main cause of the technical problem and the ideal state are realized. With respect to the resin layer 42, for instance, thermal conductivity of the resin, thermal shrinkage of the resin, resin Tg, hydrogen bond cleavage property and so forth are listed. With respect to the aluminum substrate 41, thermal conductivity of aluminum, surface roughness of the aluminum substrate and so forth are listed. With respect to the IR dye, for instance, IR dye decoloring property, IR dye concentration and so forth are listed.

In the last step, a means for realizing the ideal state is established by combining the movement of the energy and that of the substances with the attributes listed in the frame F. The resultant means is written in the frame G: tasks in the phenomenon-attribute analysis.

For example, a means 1 for realizing the ideal state 1 may be to prevent the heat diffusion in the lateral directions by forming the resin layer 42 with a heat shrinking resin which creates an air layer barrier around the image section. A means 2 for realizing the ideal state 2 may be to transfer the heat through melting-condensation of the resin by using a low Tg resin. A means 3 for realizing the ideal state 3 may be to move the heating surface in the lower direction by using a decoloring IR dye which loses color after the heat is generated. A means 4 for realizing the ideal state 4 may be to introduce an acid releasing material which releases the acid when irradiated. Note that in the frame G, means other than those corresponding to the ideal state are also listed to further examine the solution of the technical problem in multifaceted ways.

As described above, the ideal state is defined in which the main cause of the technical problem is eliminated, and the movements of the energy and the substances are examined to realize the ideal state. Thereby, the direction of the solution concept becomes clear. Further, the optimum solution concept is obtained by listing the attributes related to the main cause of the technical problem and the ideal state, and by examining the listed attributes in combination with the above movements of the energy and the substances.

In the present invention, the functions are clarified and the main cause of the technical problem is identified by analyzing the sub-process formed by dividing the conversion process based on the condition changes. Accordingly, the present invention is useful in solving the technical problem even in a technical system whose functions are not clear. It is also possible to use the present invention to establish a technology development road map in anticipation of the future needs. Since the solution concept is created on the basis of the relationships between the ideal state and the technical problem, the optimum solution is derived.

In the above embodiment, the main cause of the technical problem is estimated by the analyses on paper to create the solution concept. It is also possible to integrate the above steps into a computer program and implement it in a computer. Hereinafter, a computer program for estimating a main cause of a technical problem is described to which the present invention is applied (hereinafter referred to as an estimation program). The estimation program is characterized in that the phenomenon-attribute analysis table, which is useful for the estimation of the main cause of the technical problem and the creation of the solution concept, is automatically produced by inputting the items regarding the technical system by following the input items sequentially displayed on a monitor.

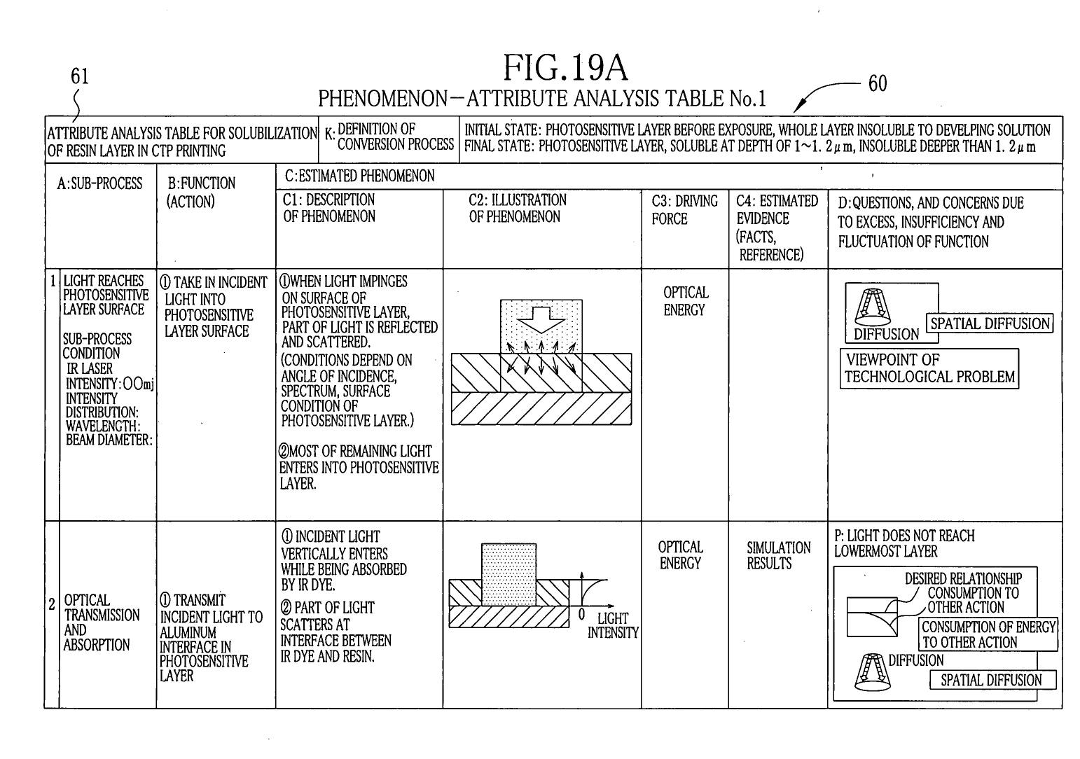

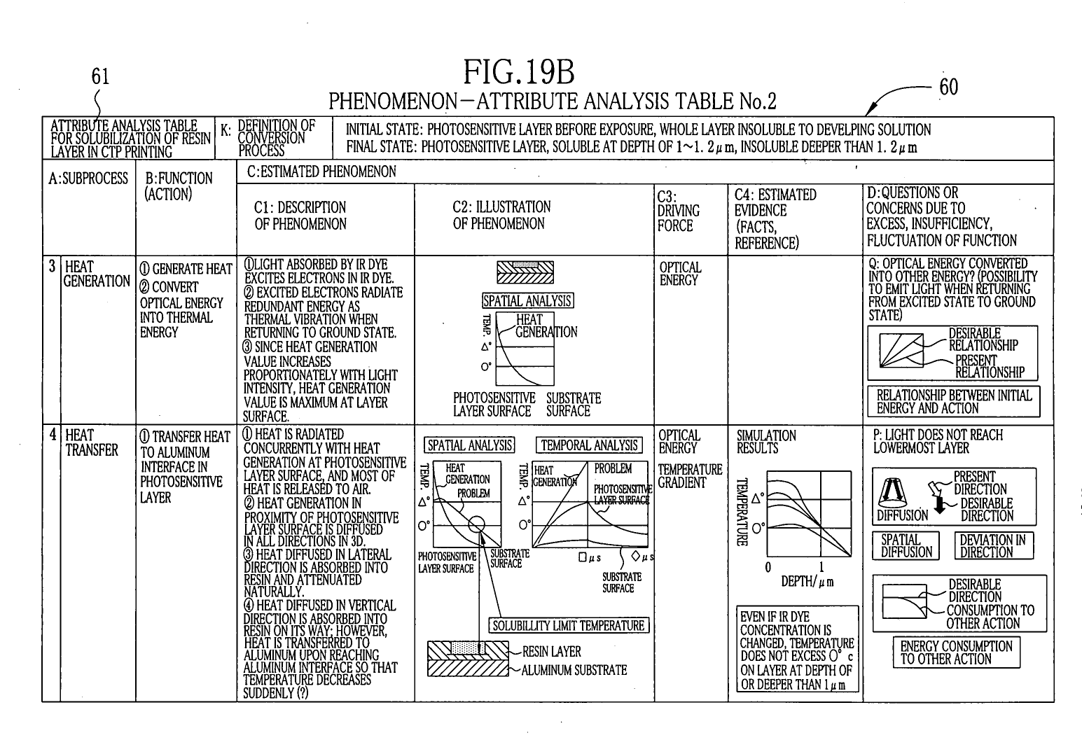

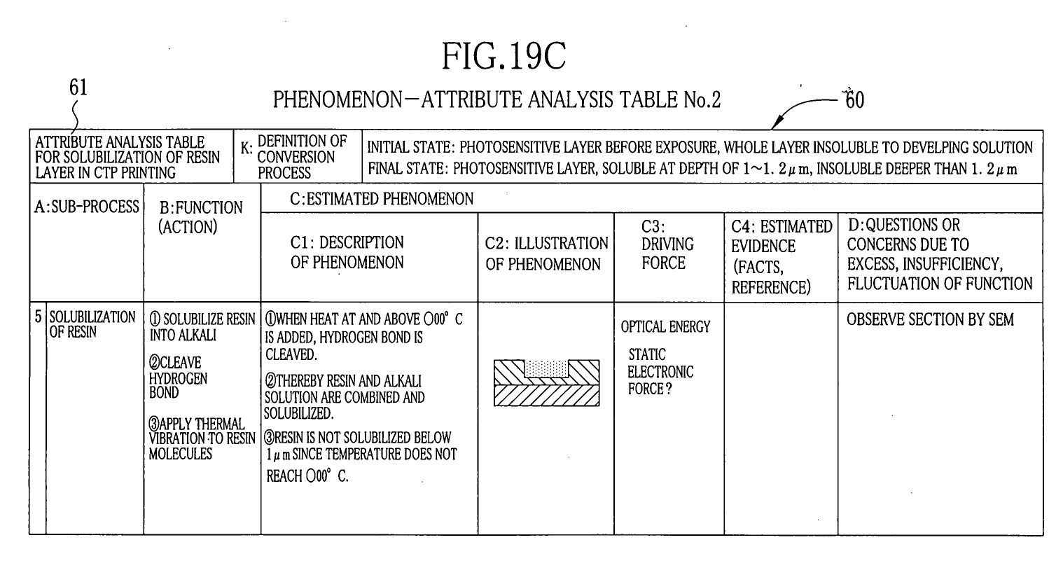

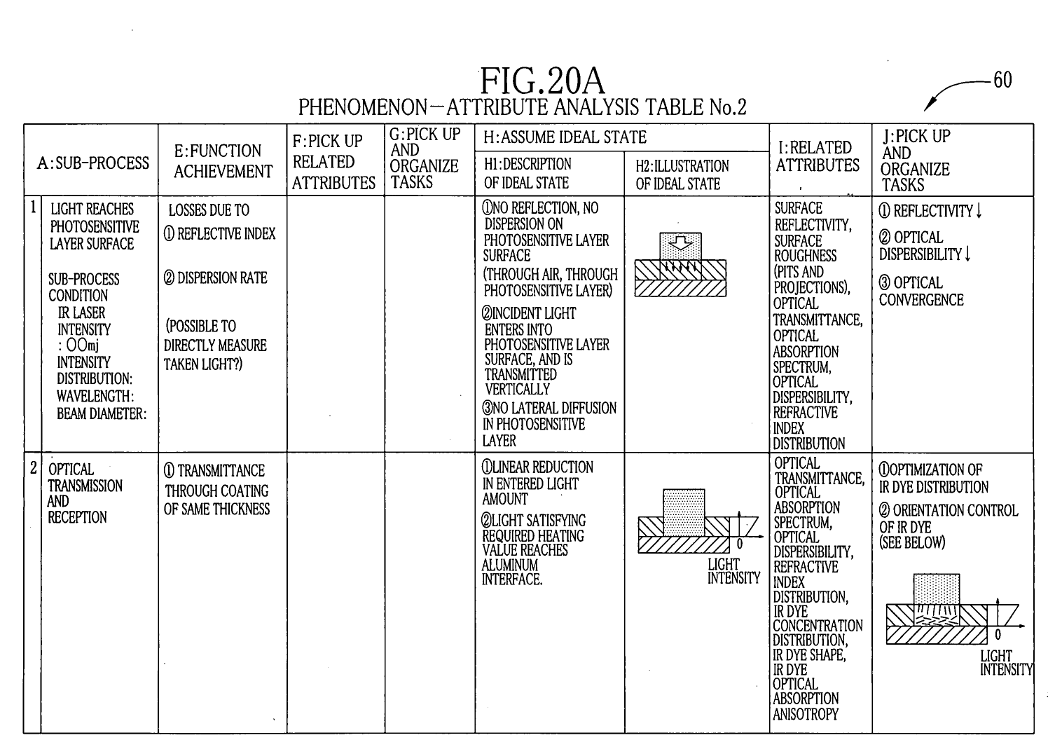

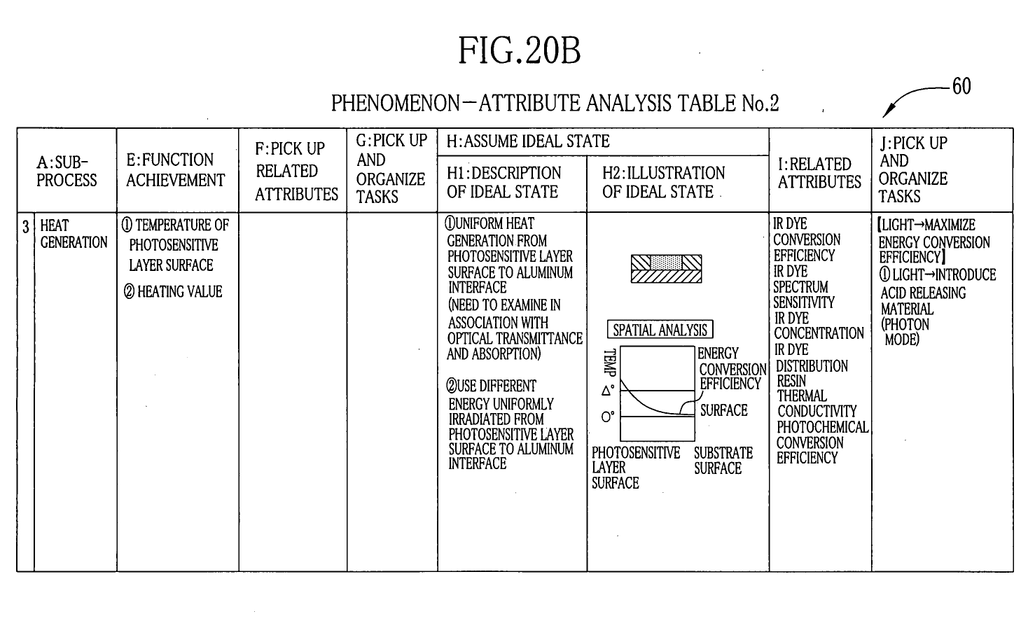

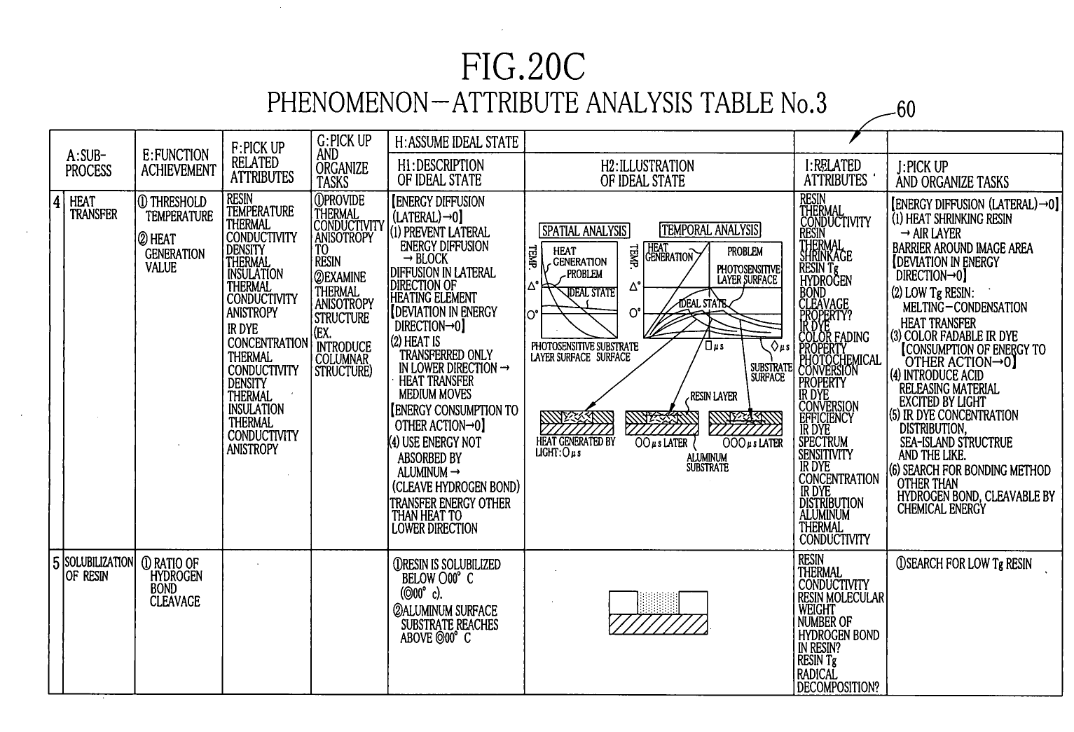

In FIGS. 19A, 19B, 19C, 20A, 20B and 20C, an example of a phenomenon-attribute analysis table 60 is illustrated which is related to solubilization of the resin layer on the CTP printing plate described in the above embodiment. In an upper portion of the phenomenon-attribute analysis table 60, a title section 61 is displayed. On a right side of the title section 61, a section K: conversion process is displayed in which an initial state and a final state are described when the technical system is regarded as one conversion system. Below the title section 61 and the section K, plural sub-process analyzing sections are provided in which the sub-processes formed by dividing the conversion process according to condition changes, and the content of the analysis of each sub-process are described. In this embodiment, the phenomenon-attribute analysis table is spread over three pages for the facilitation of reading. However, at the time of actual printing, it is possible to print the phenomenon-attribute analysis table in one sheet or in plural sheets.

In the title section 61 of the above phenomenon-attribute analysis table 60, a title, for instance, “Phenomenon-attribute analysis regarding solubilization of resin layer on CTP printing plate” is indicated so that the content of the table is immediately identified. The title is the same as a file name used for storing the table produced by the estimation program as data. It is also possible to input the title. In the section K: conversion process, the initial and final states are described when the technical system which is the exposure of the CTP printing plate is regarded as one conversion system.

At a left end of the sub-process analysis section, the sub-process names are listed under a section A: sub-process name. In the lateral sections, the analysis sections B to J are provided in which the results of the analyses regarding the phenomenon and the attributes of each sub-process are described. Detailed explanation on the analysis sections B to E and H is omitted since these sections have the same contents as the phenomenon-attribute analysis table in the FIG. 15 explained in the previous embodiment.

In the analysis sections F: related attributes and G: tasks, design parameters, actions to be implemented and so forth are described to achieve the function achievement evaluation items estimated in the analysis sections B to E. In the analysis sections I: related attributes and J: tasks, design parameters and actions to be implemented are described to achieve the ideal state in which the technical problem does not exist estimated in the analysis section H.

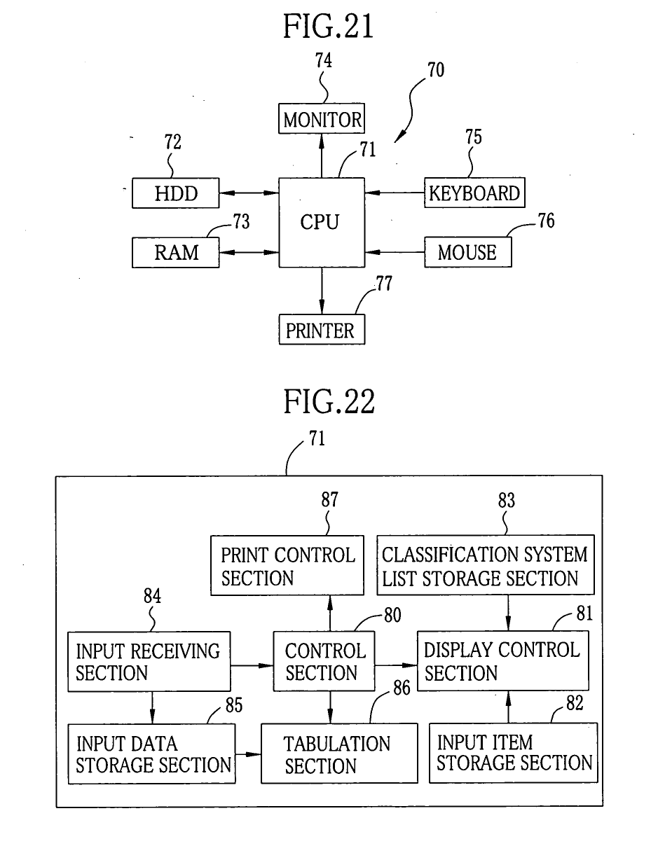

In FIG. 21, a computer system 70 is constituted of a CPU 71, an HDD 72, a RAM 73, a monitor 74, a keyboard 75, a mouse 76 and a printer 77. The CPU 71 performs various arithmetic processing. The operating system (OS) and the estimation program are stored in the HDD 72. The RAM 73 reads the OS or the estimation program for the arithmetic processing in the CPU 71 at the startup of the computer system 70 or the estimation program. The monitor 74 displays the OS screen and the estimation program screen. The keyboard 75 and the mouse 76 are used for operating the OS and the estimation program. The printer 77 prints the results of the estimation obtained by the estimation program.

In FIG. 22, a control section 80 integratedly controls each section of the computer system 70 according to process steps predetermined by the estimation program. A display control section 81 has a function to display the estimation program screen on the monitor 74. The input items and input support items constituting a part of the estimation program screen are stored in an input item storage section 82. In a classification system list storage section 83, the technical problem classification system list and technical problem classification symbol list are stored so as to be referred to while the contents regarding the technical problem are input. An input receiving section 84 has a function to receive the contents input by the keyboard 75 and/or the mouse 76. The received contents are stored in an input data storage section 85. A tabulation section 86 produces the phenomenon-attribute analysis table according to the input contents read from the input data storage section 85. The phenomenon-attribute analysis table is displayed on the monitor 74 by the display control section 81, converted into print data by a print control section 87 and output to the printer 77.

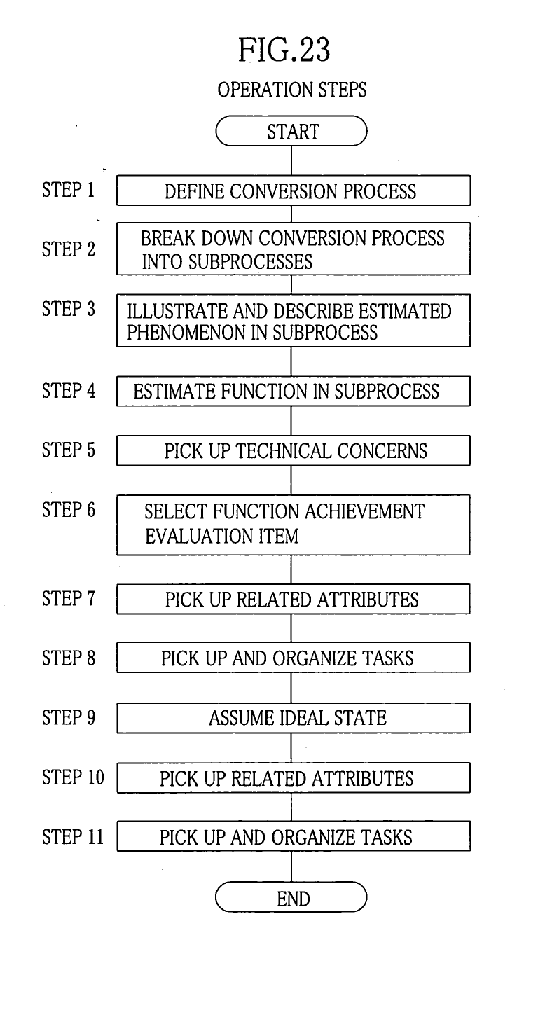

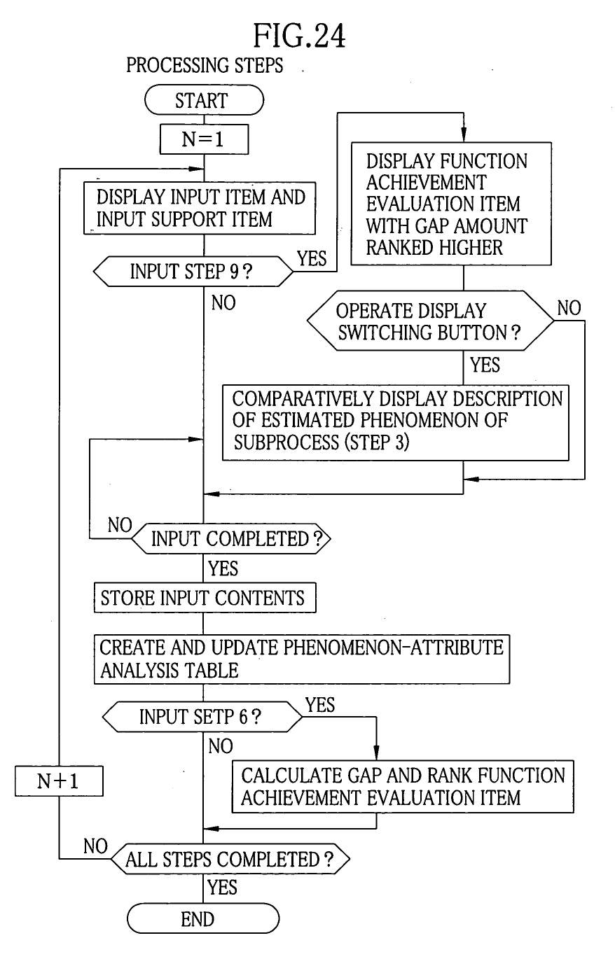

In FIGS. 23 and 24, the operation steps are constituted of steps 1 to 8 in which various kinds of information are input to estimate the main cause of the technical problem, and the steps 9 to 11 in which various kinds of information is input to create the solution concept of the technical problem. The input contents in each step are written in the corresponding section of the phenomenon-attribute analysis table.

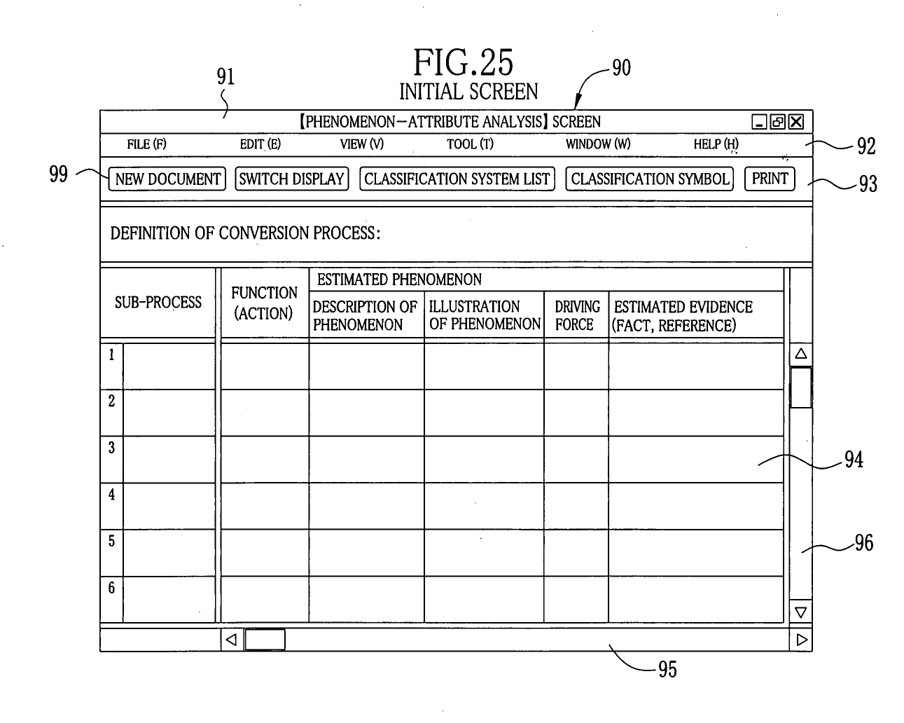

In FIG. 25, in an uppermost portion of an operation screen 90 in an initial state displayed on the monitor 74 when the estimation program is started, a title section 91 is provided in which the program name is displayed. In the title section 91, the file name, data path and so forth are also displayed when the previously produced phenomenon-attribute analysis table is opened. Below the title section 91, a menu section 92 and a button section 93 are disposed. In the menu section 92, various menus used for operating the estimation program are displalyed. In the button section 93, the menus frequently used are provided as buttons. Below the menu section 92 and the button section 93, a format 94 of the phenomenon-attribute analysis table with blank boxes are displayed. Not all blank boxes of the format 94 are displayed on the operation screen 90. However, the undisplayed boxes of the phenomenon-attribute analysis table are displayed by operating the scroll bars 95, 96 provided in the lower and side portions of the operation screen 90.

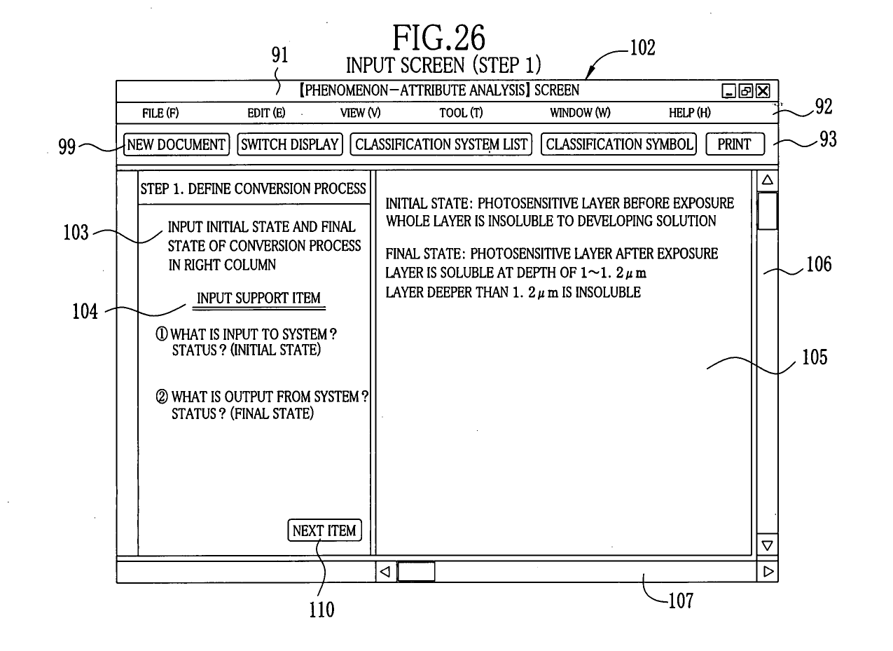

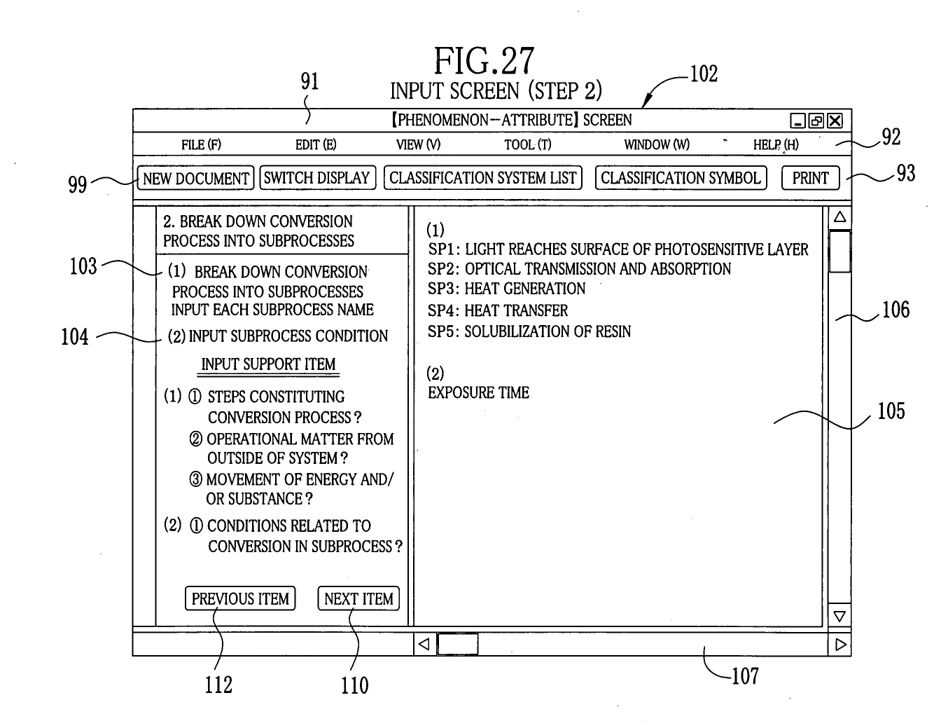

Production of a new phenomenon-attribute analysis table is started by operating a new document button 99 in the button section 93 by using the mouse 76. As shown in a flow chart in FIG. 24, when the new document button 99 is operated, the operation screen 90 is switched to an input screen 102 shown in FIG. 26. Thereafter, a count value N of a counter provided in the control section 80 is set to 1, and the input items 103 showing contents to be input in the step 1, and the input support items 104 for supporting the input items 103 are displayed in the lower left portion of the button section 93.

Often engineers have not mastered the estimation program or the technical problem estimation method of the present invention hardly identify the contents only by looking at the input items. To solve this problem, the input support items 104 are displayed together with the input items 103. The input support items 104 show concrete contents to be input in a question form to elaborate on the input items 103. On the left side of the input items 103, an input section 105 to which the contents are actually input is displayed. The input section 105 is scrolled by using the scroll bars 106, 107. An amount to be input in the input section 105 is greater than that actually displayed.

In a lower portion of the input support item 104, a next item button 110 is provided. The next item button 110 is operated when the input in the step 1 is completed. When the next item button 110 is operated, the operation screen is switched as shown in FIG. 27 and the input items 103 and the input support items 104 in the step 2 are displayed. The contents in the input section 105 input in the step 1 is stored in the input content storage section 85 and the phenomenon-attribute analysis table is produced or updated by the tabulation section 86.

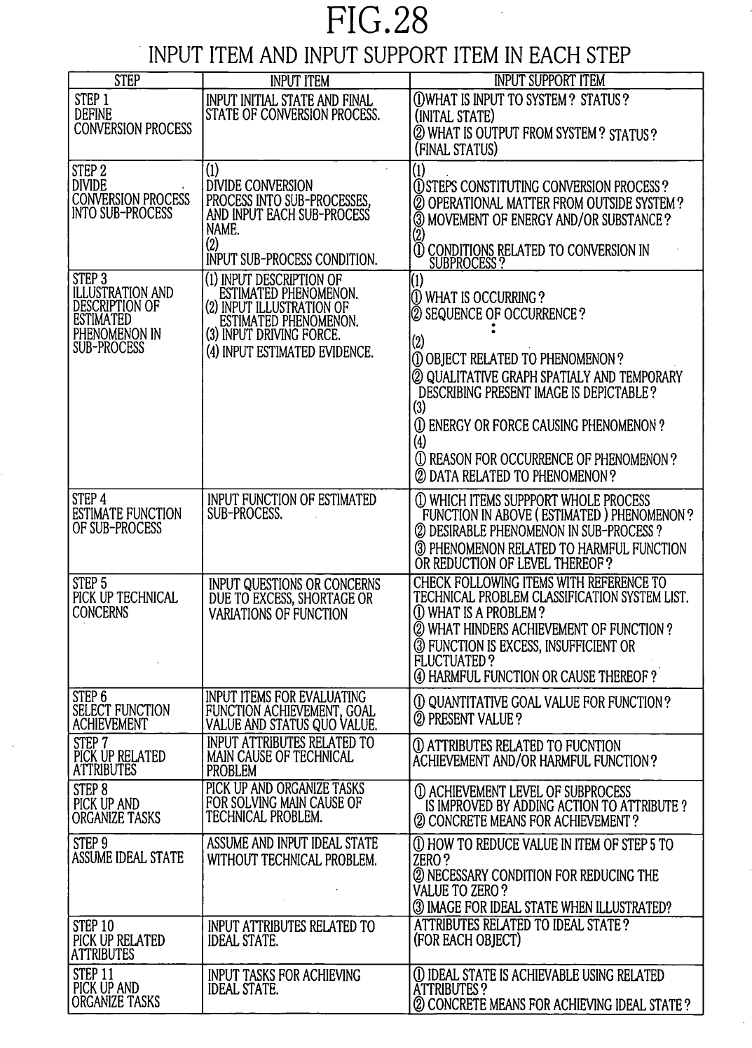

In the step 2 and after, a previous item button 112 is displayed together with the next item button 110 to change the previously input contents. As described above, since the phenomenon-attribute analysis table is produced by executing the input operation by following the steps 1 to 11 displayed on the monitor 74, even the inexperienced engineers are able to estimate the main cause of the technical problem and to create the solution concept easily. The input items 103 and the input support items 104 displayed in each step are listed in FIG. 28.

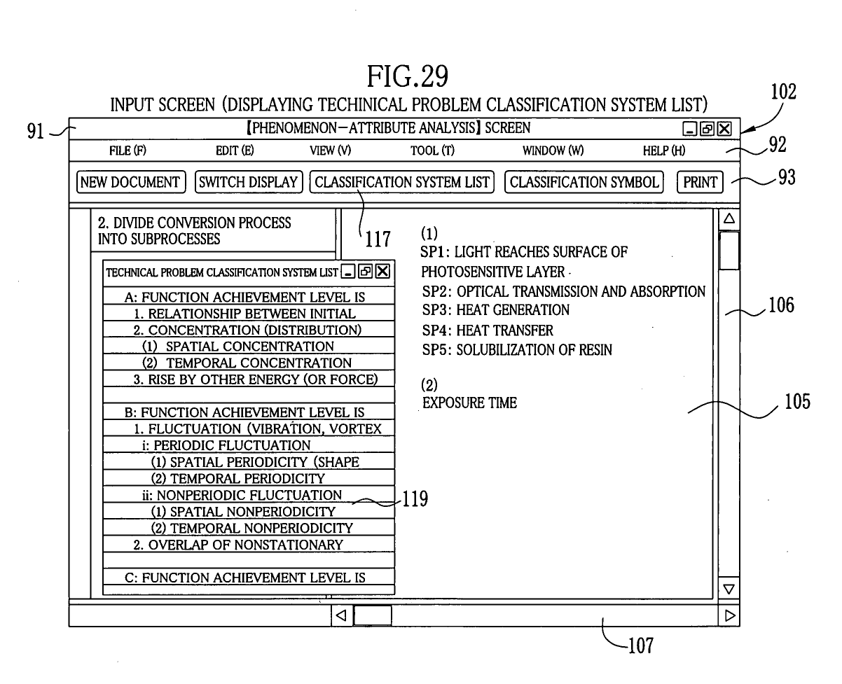

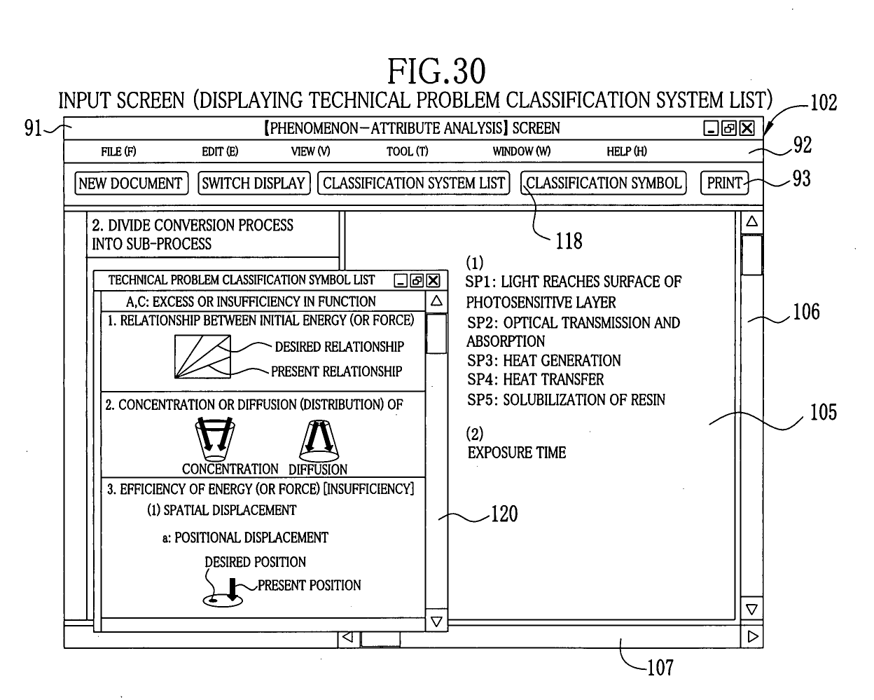

In each step, there may be a need to refer to the technical problem classification system list and the technical problem classification symbol. In such cases, a technical classification system list button 117 or a technical problem classification symbol button 118 in the button section 93 is operated. Upon detecting this operation, the control section 80 reads either list from the classification system list storage section 83 and display a technical problem classification system list 119 (see FIG. 7) or a technical problem classification symbol list 120 (see FIGS. 8A and 8B) as shown in FIGS. 29 and 30. Thereby, each list may be referred to as necessary. Accordingly, the estimation of the main cause and the creation of the solution concept are properly performed.

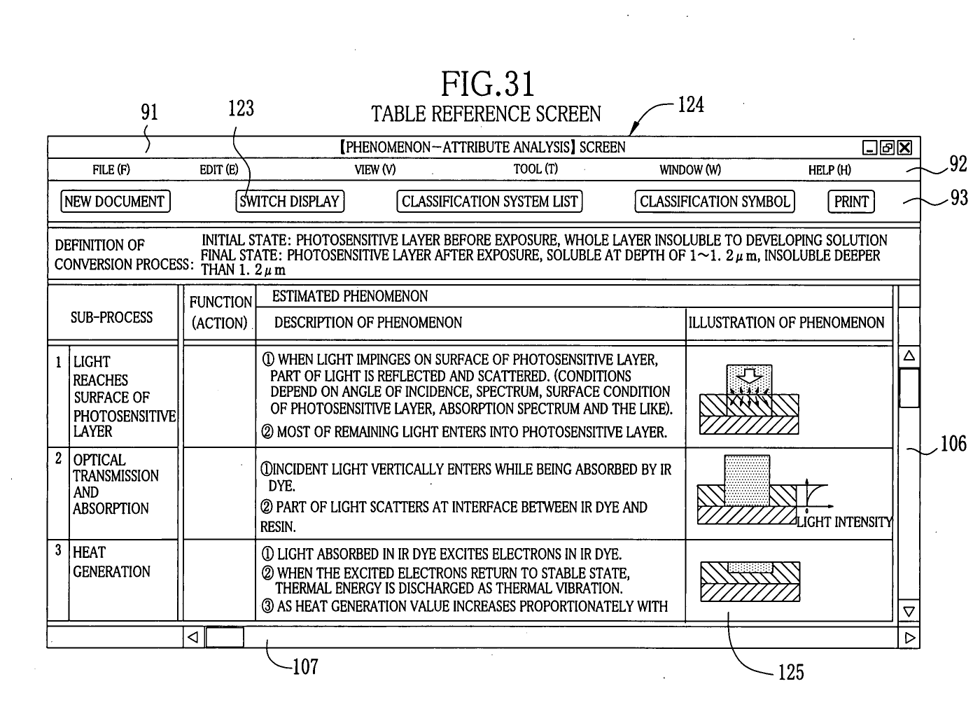

As shown in FIG. 31, when a display switching button 123 in the button section 93 is operated, the display on the monitor 74 is switched from the input screen 102 to a table reference screen 124 to display a phenomenon-attribute analysis table 125 under creation. Thus, the input operation is performed while checking the whole conversion process so that the estimation of the main cause of the technical problem and the creation of the solution concept are performed more properly.

In the step 6 of the estimation program of the present invention, the function achievement evaluation item on which the function of the sub-process is evaluated along with the goal value and the present value thereof are input in the same manner as the above embodiment. As shown in the flow chart in FIG. 24, the control section 80 calculates a difference between the goal value and the present value, that is, the gap, based on the input contents in the step 6. The function achievement evaluation items are ranked according to the gap amounts. Thus, the item having the large gap amount, that is, the technical problem having the large gap amount is quantitatively obtained.

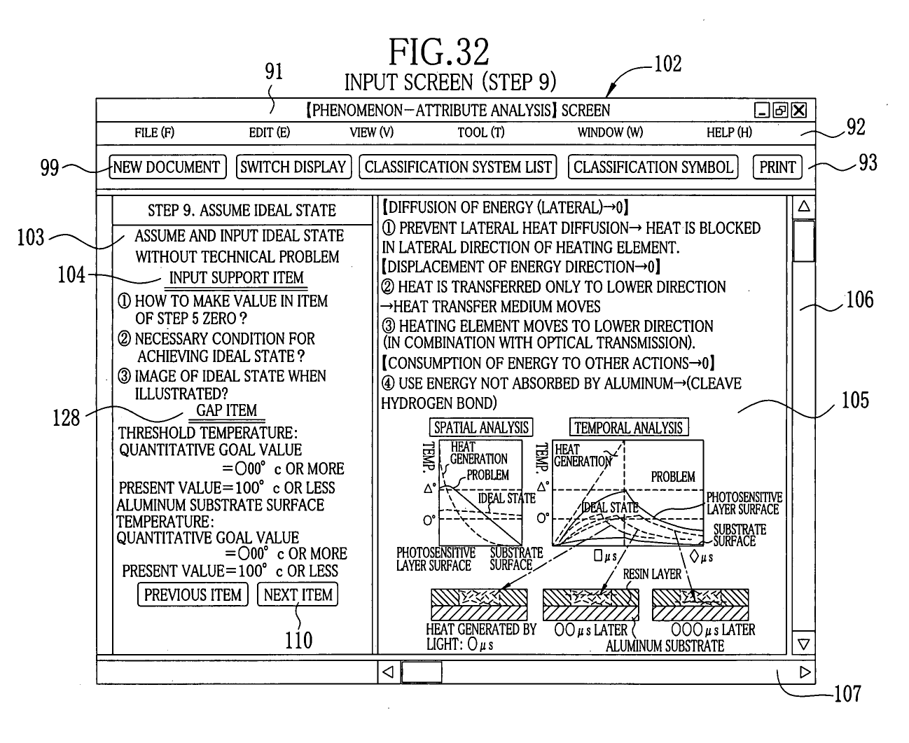

As shown in FIG. 32, the function achievement evaluation items in higher ranks are displayed as gap items 128 at a lower portion of the input support items 104. Thereby, it becomes easy to assume the state not having the gap as the ideal state, helping to create the solution concept. Regarding the number of the gap items displayed in the step 9, all gap items or just several gap items (three items, for example) ranked high may be displayed. It is also possible to display the gap items exceeding a predetermined amount. It is preferable to set the display setting as necessary. The items may be highlighted to attract the attention of the engineer who works on the program.

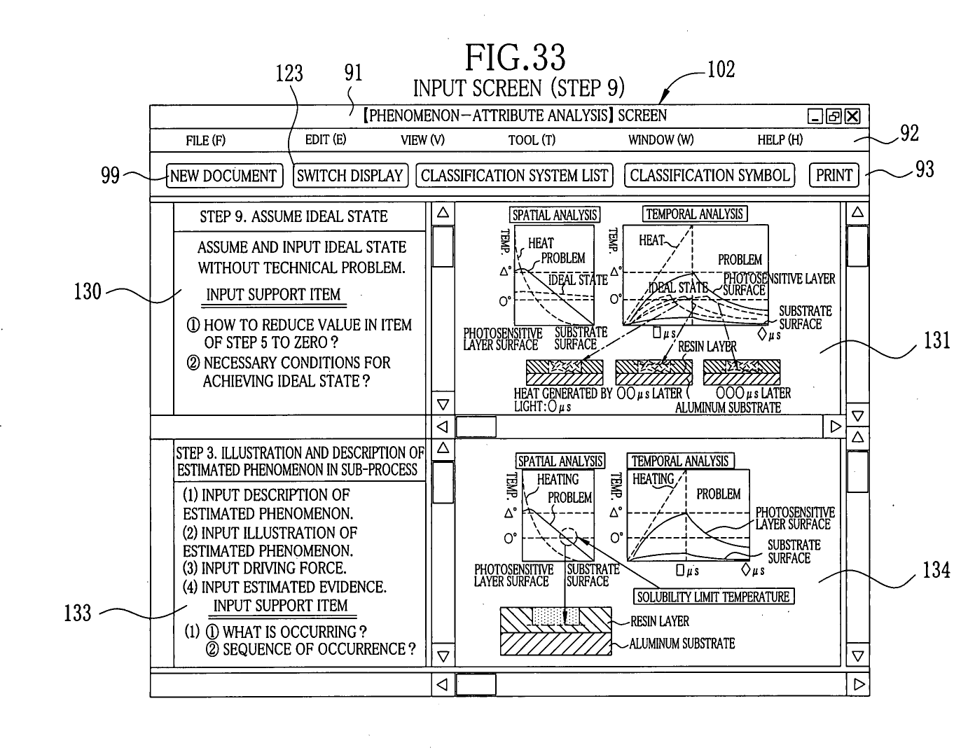

As shown in FIG. 33, in the step 9, an input item 133 and an input section 134 for the step 3 are displayed next to the input item 130 and the input section 131 for the step 9 by operating the display switching button 123. Thereby the ideal state is input while the estimated phenomenon in the sub-process is referred to, and thus the input efficiency is improved. In addition, the contents input in the step 3 are changed while the contents input in steps up to the step 9 are referred to. Accordingly, a phenomenon-attribute analysis table is created at a higher level of perfection.

After the completion of the phenomenon-attribute analysis table by following the above operation steps, a print button 137 in the button section 93 is operated to print the phenomenon-attribute analysis table by the printer 77. It may also be possible to change the print setting such that the items to be printed are selected at the time of printing.

It is also possible to determine an evaluation value of each basic technical problem listed in the technical problem classification system list according to how far the problem deviates from the ideal state. Thereby, a degree of improvement is estimated with respect to each main cause of the technical problem when the ideal state is achieved. The above function may be incorporated in the estimation program as a default or as an option. When there are new findings in the field relevant to the present invention, it is also possible to update the estimation program by incorporating the new findings into the estimation program.

In the above embodiment, it is explained that the steps 1 to 11 are performed. However, it is also possible to select the operation steps according to objectives, for instance, the steps 1 to 8 for the estimation of the technical-problem, the steps 1 to 11 for the estimation of the technical problem and the creation of the solution concept, and so forth. When only the steps 1 to 8 are performed, a phenomenon-attribute analysis table is produced in which the frames H to J are omitted. Further, in the above embodiment, the input operation is performed by following the steps according to the directions from the computer. However, the input operation may be performed according to needs and preferences of the engineer. Further, in the above embodiment, an example is explained in which the estimation program is installed in a general-purpose computer. However, it is also possible to configure a main cause estimation apparatus in which the estimation program is installed.

In each of the above embodiments, the CTP printing plate is explained as an example. However, the present invention is applicable to various technical systems.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A method for estimating a main cause of a technical problem comprising the steps of:
(a) organizing functions of a technical system, in which said technical problem is estimated, into a single conversion process for converting an input into an output;
(b) dividing said conversion process into plural sub-processes according to condition changes in said conversion process;
(c) analyzing a phenomenon in each of said sub-processes and estimating a function of each of said sub-processes;
(d) estimating a sub-process in which said technical problem occurs; and
(e) estimating a main cause of said technical problem with referring to a technical problem classification system list in which various sorts of technical problems and main causes thereof are classified and systematized.

2. A method according to claim 1, wherein said phenomenon means an influence exerted by an attribute of an object on an attribute of another object in said technical system under a certain field which is energy and force, and wherein an action caused by said influence is estimated as said function if said action is controllable and provides a useful effect, while said action is estimated as said technical problem if said action is not controllable and exerts a harmful influence.

3. A method according to claim 1, wherein said step (d) further includes the step of analyzing a goal level and a present level of achievement in said function of said sub-process and estimating a gap between said goal level and said present level as said technical problem.

4. A method according to claim 1, wherein in said step (c), a phenomenon-attribute analysis flow composed of plural questions interrelating to said phenomenon is used, and wherein said phenomenon and said function of said sub-process are estimated by sequentially answering each of said questions.

5. A method according to claim 1, wherein in said step (c), said phenomenon is explained with text and illustration.

6. A method according to claim 2, wherein said technical problem classification system list classifies said technical problem under categories of at least an achievement level of said function of said sub-process, stability of said function achievement level, and said harmful function, and wherein said each category is classified into plural items representing said main causes based on temporal and spatial perspectives.

7. A method according to claim 6, wherein technical problem classification symbols symbolizing contents of items in said technical problem classification system list are used.

8. A method for creating a solution concept for solving a technical problem comprising the steps of:
(a) organizing functions of a technical system, in which said main cause is estimated, into a single conversion process for converting an input into an output;
(b) dividing said conversion process into plural sub-processes according to condition changes in said conversion process;
(c) analyzing a phenomenon in each of said sub-processes and estimating a function of each of said sub-processes;
(d) estimating a sub-process in which said technical problem occurs;
(e) estimating a main cause of said technical problem with referring to a technical problem classification system list in which various sorts of technical problems and main causes thereof are classified and systematized;
(f) assuming an ideal state in which said technical problem does not exist, and examining movements of energy and substances to obtain said ideal state;
(g) listing attributes of materials and of members related to said ideal state; and
(h) establishing a means for achieving said ideal state by combining said examined movements, and said listed attributes.

9. A method according to claim 8, wherein said technical problem classification system list is classified into plural items representing said main causes of said various technical problems based on temporal and spatial perspectives, and wherein said ideal state is a state in which a value of said item corresponding to said estimated main cause is reduced to zero.

10. A method according to claim 8, wherein in said step (f), an estimated phenomenon in said ideal state is explained with text and illustration.

11. A computer program for executing a method for estimating a main cause of a technical problem occurring in a technical system, said computer program comprising the steps of:
(a) assuming a function of said whole technical system as a single conversion process in which an input is converted into an output, and inputting an initial state and a final state of said conversion process;
(b) inputting sub-processes created by dividing said conversion process based on condition changes in said conversion process;
(c) inputting an explanation of a phenomenon occurring in each of said sub-processes;
(d) inputting an estimated function of each of said sub-processes;
(e) displaying a technical problem classification system list in which various sorts of technical problems and main cause thereof are classified and systematized, and selecting a main cause of said technical problem occurring in one of said sub-processes from said technical problem classification system list and inputting said selected main cause; and
(f) producing a phenomenon-attribute analysis table based on contents input in said steps (a) to (e).

12. A computer program according to claim 11, said step (e) further including the steps of:
(e1) inputting a description of an ideal state of said sub-process with said technical problem in which said technical problem does not exist;
(e2) inputting attributes of materials and of members related to said ideal state; and
(e3) inputting a means for achieving said ideal state based on contents input in said steps (e2) and (e3).

13. A computer program according to claim 12, wherein in step (e1), said inputted explanation of said phenomenon in said sub-process with said technical problem is displayed for comparison.

14. A computer program according to claim 12, said step
(d) further including the steps of:
(d1) inputting both a function achievement evaluation item to evaluate an achievement of said function in each of said sub-processes, and a goal value and a present value of said function achievement evaluation item; and
(d2) obtaining a difference between said goal value and said present value, and ranking said function achievement evaluation items according to an amount of said difference.

15. A computer program according to claim 14, wherein in said step (e1), at least one of said function achievement evaluation items ranked higher is displayed.

16. A computer program according to claim 11, wherein said technical problem classification system list includes technical problem classification symbols illustrating main causes of technical problems.

17. A computer program according to claim 11, wherein input items showing contents to be input and input support items elaborating on said input items are displayed while said input operations are performed.

18. A computer program according to claim 11, wherein said technical problem classification system list is displayed in accordance with a calling operation.
